(19) United States
(12) Patent Application Publication
(10) Pub. No.: US 2007/0027955 A1
(43) Pub. Date: Feb. 1, 2007

(54) Systems, methods and apparatus of an email client

(75) Inventors: Terry A. Voss, Spokane, WA (US); Martin W. Howser, Spokane, WA (US)

Correspondence Address: RAMIREZ & SMITH, PO BOX 2843, SPOKANE, WA, 99220-2843, US

(73) Assignee: JWJ Software, LLC., Spokane, WA (US)

(21) Appl. No.: 11/191,358

(22) Filed: Jul. 28, 2005

(51) Int. Cl. G06F 15/16

(52) U.S. Cl. 709/206

(57) ABSTRACT

Systems, methods and apparatus are provided through which an email client accesses email data through an interface to a database manager, the database manager having a high level security manager.

### FIELD OF THE INVENTION

This invention relates generally to client/server systems, and more particularly to email clients.

### BACKGROUND OF THE INVENTION

Email is considered to be the “killer” application that helped create wide-spread popularity and adoption of the Internet. The ability to exchange information and files within a few seconds between any points on Earth is tremendously useful and may have provided significant economic growth in the Western world and possibly to the economies of all nations. Email has affected the structure and organization of corporations, enabling companies to disburse and distribute work and tasks between remote locations to an extent that could only be done with the nearly instant and convenient exchange of data that email provides.

As discussed above, the commercial value and function of email is tremendous, however, the function of conventional email clients present problems. One problem is the instability of the email clients. Email clients are notorious for ceasing operation without warning. This abrupt cessation is known as “crashing” or “abending.” In some cases, an email client while crashing will damage a database of email data that the email client was accessing at the time of the crash that requires a backup copy of the email database to be restored, which typically results in a permanent loss of some email data. In other cases, an email client while crashing can cause the computer to enter into a mode of unoperability, known as “hung” that requires rebooting the computer. All of these problems result in a loss of productivity and high level of dissatisfaction with email clients among the users of the email clients.

In particular, conventional executable email client files are a binary image of machine executable computer instructions that are loaded into memory of a computer. A program counter is set to the beginning location of the computer instructions. An operating system of the computer is not involved in overseeing the execution of the computer instructions, other than protections in place around memory management and port I/O. However, the operating system has very little information on what the computer instructions are doing. Therefore, errant computer instructions often wreak havoc on the stability of the operating system and the computer.

In addition, conventional email clients have very limited ability to prioritize emails that have been received. In particular, one conventional email client has the ability to sort emails in particular folder according to any one of the following fields or criteria: Criteria assigned to the email by the sender (importance), icon, flag status, presence of an attachment, sender, subject, date received and size. This scope of sorting/prioritization often does not readily reveal a particular email that a user is trying to locate. Often, a user will resort to searching the entire database of emails to find a particular email. In some cases, users will save multiple copies of an email on various subdirectories in order to make locating the email easier later on.

Also, conventional email clients have difficulty displaying email messages that are encoded in hyper text markup language (HTML). To display a HTML encoded email message, conventional email clients invoke a browser. The browser then displays the HTML-encoded email. The invocation of a browser introduces execution errors of the browser into the execution of the email client.

Furthermore, conventional email clients are limited in the total of email and attachments that can be stored in one email file. For example, on a computer running the Microsoft Windows® operating system, the maximum file size of an email file is often two gigabytes. In that case, the total amount of emails and attachments that can be stored in the email file is two gigabytes. Some users fill up an email file of two gigabytes in a couple of years, and in some unusual situations, a few weeks. Some conventional email clients allow some of the data in the email to be archived, but archival email files must be inconveniently searched separately when the archived email data is retrieved.

For the reasons stated above, and for other reasons stated below which will become apparent to those skilled in the art upon reading and understanding the present specification, there is a need in the art for an operationally stable email client. There is also a need for improved sorting/prioritization of emails. There is also a need for less invocation of browser errors by an email client. In addition, there is a need for an email client that provides more storage for email data including attachments, without having to resort to archival files.

### BRIEF DESCRIPTION OF THE INVENTION

The above-mentioned shortcomings, disadvantages and problems are addressed herein, which will be understood by reading and studying the following specification.

In one aspect, an apparatus to provide a reliable apparatus for managing email data comprises an apparatus operable to store at least a portion of the email through an interface to a database manager; the database manager having a high level security manager, and an apparatus operable to retrieve email data through the interface to the database manager.

In another aspect, an apparatus to provide a reliable apparatus of managing email data, an apparatus operable to store at least a portion of the email through an interface to a relational database manager and an apparatus operable to retrieve email data through the interface to the relational database manager.

In yet another aspect, an apparatus to provide a reliable apparatus of managing email data, the apparatus comprising an apparatus operable to store at least a portion of the email through an interface to a structured-query-language database manager and an apparatus operable to retrieve email data through the interface to the structured-query-language database manager.

In still another aspect, a method to manage email associations, comprises receiving an email, determining that a sender of the email is stored in a database and creating an association in the database between the email and the sender.

In a further aspect, a method to provide storage for email data including attachments, comprises creating a file structure that is operable to store email attachment data and creating a file structure that is operable to store email data other than the email attachment data.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram that provides an overview of a system to provide a reliable apparatus of managing email data;

FIG. 2 is a diagram of a table layout data structure to manage categories;

FIG. 3 is a diagram of a table layout data structure to manage persons;

FIG. 4 is a diagram of a table layout data structure to manage category and person relationships;

FIG. 5 is a diagram of a data structure to manage category and person relationships;

FIG. 6 is a diagram of a table layout data structure to manage communications

FIG. 7 is a diagram of a data structure to manage category and communications relationships;

FIG. 8 is a diagram of a data structure to manage persons and communications relationships;

FIG. 9 is a diagram of a table layout data structure to manage attachments;

FIG. 10 is a diagram of a data structure to manage communication and attachment relationships;

FIG. 11 is a diagram of a table layout data structure to manage zip codes;

FIG. 12 is a diagram of a data structure to manage persons and zip code relationships;

FIG. 13 is a diagram of a table layout data structure to manage recurrences;

FIG. 14 is a diagram of a data structure to manage persons and recurrences relationships;

FIG. 15 is a diagram of a table layout data structure to manage states;

FIG. 16 is a diagram of a data structure to manage persons and state relationships;

FIG. 17 is a diagram of a table layout data structure to manage countries;

FIG. 18 is a diagram of a data structure to manage persons and country relationships;

FIG. 19 is a diagram of a table layout data structure to manage setups;

FIG. 20 is a diagram of a table layout data structure to manage priorities;

FIG. 21 is a diagram of a table layout data structure to manage generations;

FIG. 22 is a diagram of a table layout data structure to manage email sending defaults;

FIG. 24 is a diagram of a table layout data structure to manage mdefaults;

FIG. 24 is a diagram of a table layout data structure to manage mdefaults;

FIG. 25 is a diagram of a table layout data structure to manage cdefaults;

FIG. 26 is a block diagram of a data storage architecture that provides a stable data storage environment through a transaction-based architecture;

FIG. 27 is a block diagram of a database manager that provides a stable data storage environment through a high level security manager;

FIG. 28 is a block diagram of a database manager that provides a stable data storage environment through relational data management;

FIG. 29 is a block diagram of a hardware and operating environment in which different embodiments can be practiced;

FIG. 30 is a flowchart of a method to manage email associations, according to an embodiment;

FIG. 31 is a flowchart of a method to provide storage for email data including attachments according to an embodiment;

FIG. 32 is a flowchart of a method to retrieve an email attachment according to an embodiment;

FIG. 33 is a flowchart of a method to manage auto-receive according to an embodiment;

FIG. 34 is a data flow diagram to manage attachments according to an embodiment;

FIG. 35 is a data flow diagram to manage embedded graphics according to an embodiment;

FIG. 36 is a flowchart of a method to import an email according to an embodiment;

FIG. 37 is a data flow diagram to import data into an email client according to an embodiment;

FIG. 38 is a dataflow diagram to manage email communications according to an embodiment;

FIG. 39 is a dataflow diagram to manage multiple users according to an embodiment;

FIG. 40 is a flowchart of a method to create an executable managed code email client according to an embodiment; and

FIG. 41 is a flowchart of a method to prioritize email communications according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into six sections. In the first section, a system level overview is described. In the second section, database table embodiments of apparatus are described. In the third section, database manager embodiments are described. In the fourth section, a hardware and operating environment in which embodiments may be practiced is described. In the fifth section, embodiments of methods and dataflow diagrams are described. Finally, in the sixth section, a conclusion of the detailed description is provided.

### System Level Overview

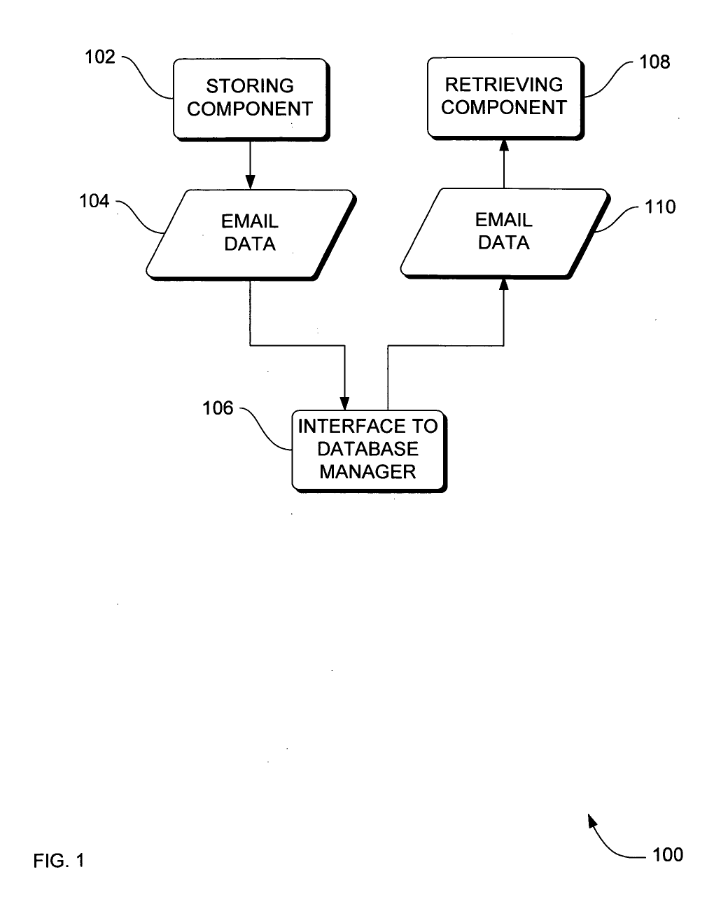

FIG. 1 is a block diagram that provides an overview of a system to provide a reliable apparatus of managing email data. System 100 solves the need in the art for an operationally stable email client

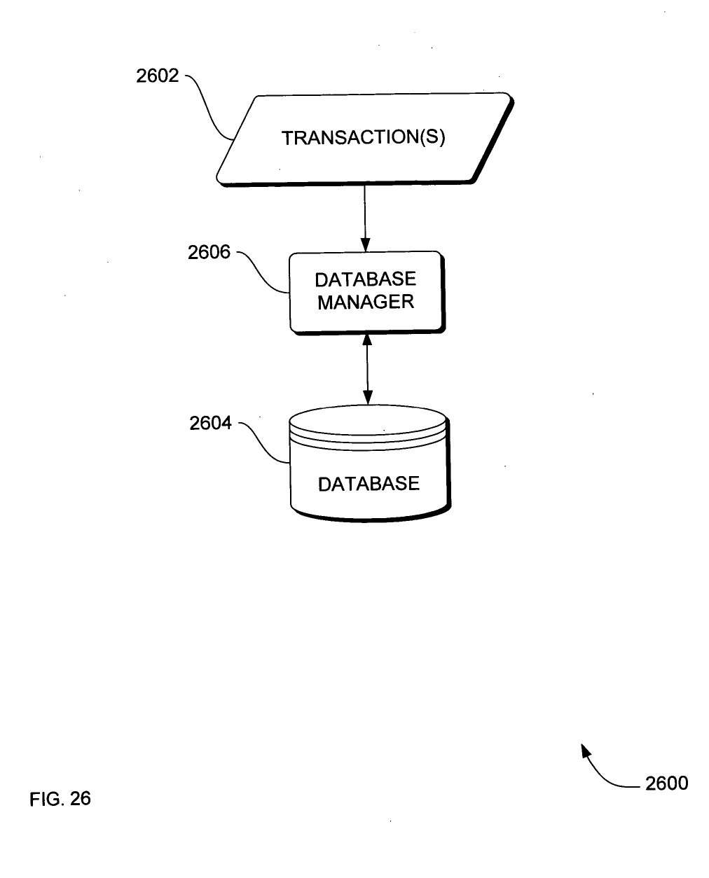

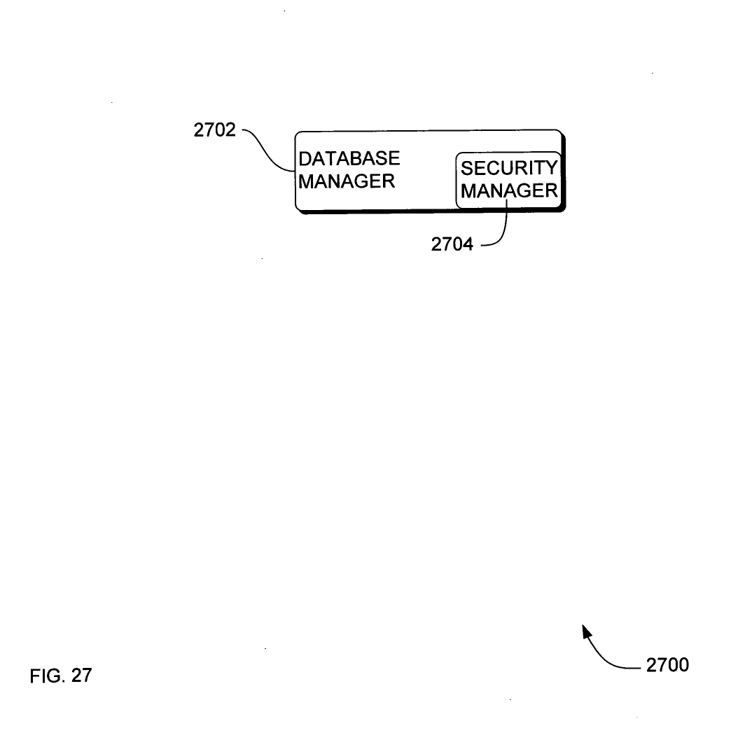

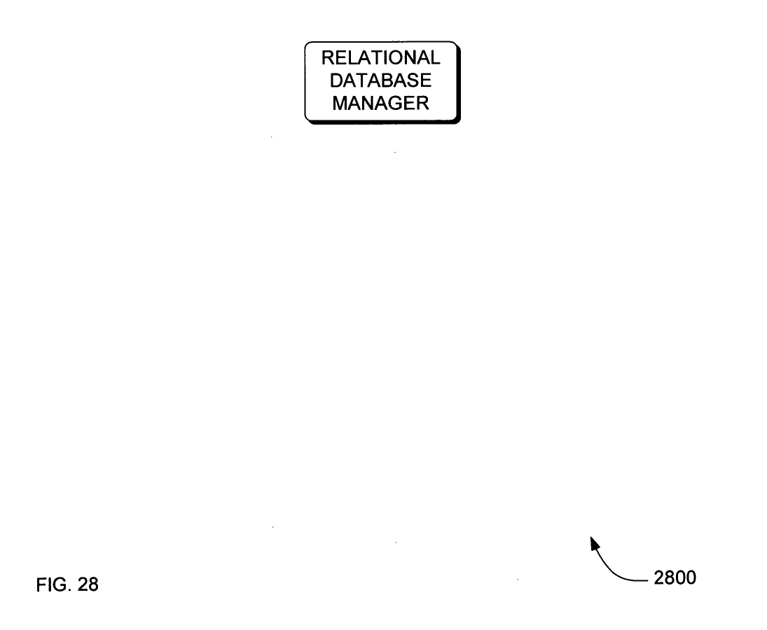

System 100 includes a storing software component 102 that is operable to store email data 104 through an interface to database manager 106. The database manager 106 provides a stable data storage environment for the email data 104. FIG. 26 below shows an embodiment in which the database manager provides a stable data storage environment through a transaction-based architecture. FIG. 27 below shows an embodiment in which the database manager provides a stable data storage environment through a high level security manager. FIG. 28 below shows an embodiment in which a relational database manager provides a stable data storage environment. In some embodiments, the format of the email data 104 is defined and prescribed in the Request for Comments published by the Internet Engineering Task Force at 1895 Preston White Drive, Suite 100, Reston, Va. 20191.

System 100 also includes a retrieving software component 108 that is operable to retrieve email data 110 through the interface 106 to a database manager. The storing software component 102 and the retrieving software component 108 are adapted to communicate with the interface 106 to a database manager.

The interface 106 to a database manager in some embodiments is a separate component from the storing software component 102 and the retrieving software component 108 as shown to the extent that the interface 106 to a database manager is separately installed on a computer that operates system 100. However, in other embodiments not shown, the interface 106 to a database manager is a component of system 100 to the extent that the interface 106 to a database manager is installed on a computer with the storing software component 102 and the retrieving software component 108.

Managing email data 104 and 110 through the interface to a database manager 106 provides an operationally stable system of managing email data 104 and 110.

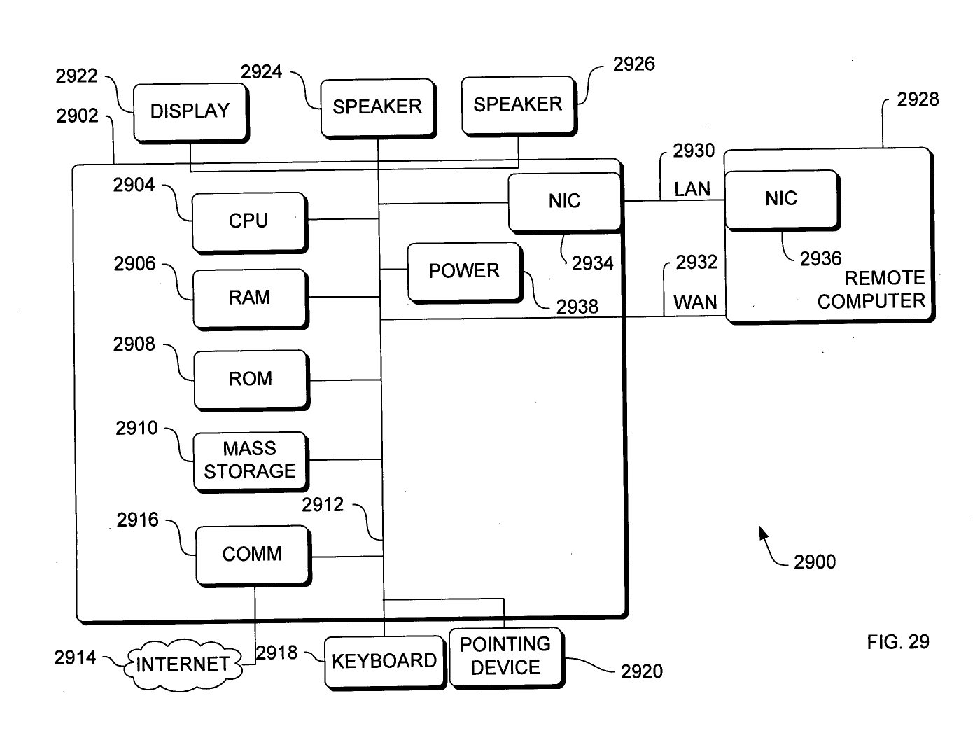

In some embodiments, the software components 102 and 108 are more generally apparatus, such as computer hardware circuitry. System 100 operates in a multi-processing, multi-threaded operating environment on a computer, such as computer 2902 in FIG. 29.

While the system 100 is not limited to any particular storing software component 102, retrieving software component 108 or an interface 106 to database manager, for sake of clarity a simplified storing software component 102, retrieving software component 108 and interface 106 to a database manager are described.

### Database Table Embodiments

In the previous section, a system level overview of the operation of an embodiment is described. In this section, the particular database implementations of such an embodiment are described. Describing the database implementations by reference to database table layouts enables one skilled in the art to develop such programs, firmware, or hardware, including such instructions to carry out the methods on suitable computers, executing the instructions from computer-readable media. Table layouts 200-2500 are implemented by software, firmware and/or hardware that is a part of, a computer, such as computer 2902 in FIG. 29.

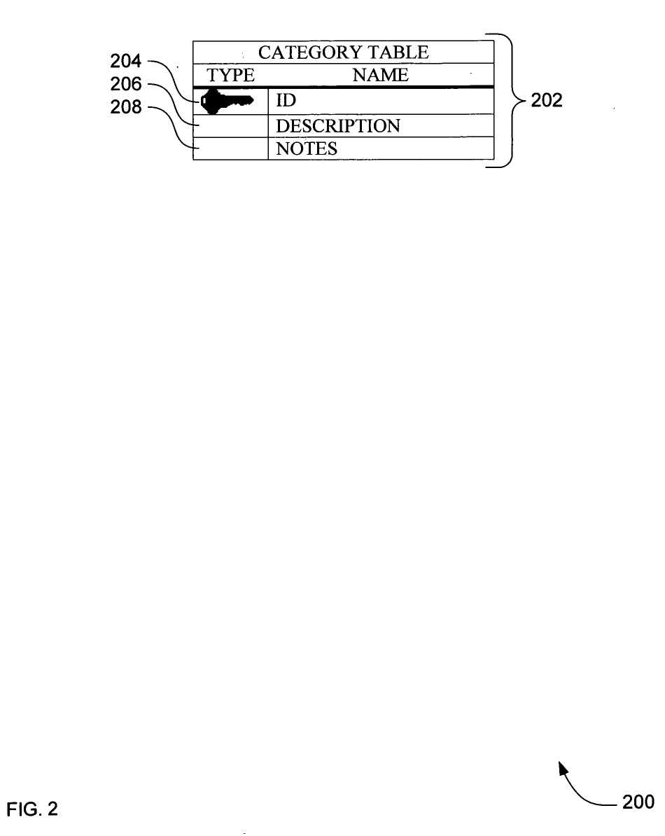

FIG. 2 is a diagram of a table layout data structure 200 to manage categories.

Table layout data structure 200 includes a table representing categories 202. Each record of the category table 202 includes an indexed key field representing an identification of a category 204, a text field representing a description of the category 206 and a text field representing a note on the category 208. Categories are groups or associations. Examples of categories are “Friday evening Volleyball Group” or “Mayoral campaign” or “heaven.” Categories are more generally any relationship.

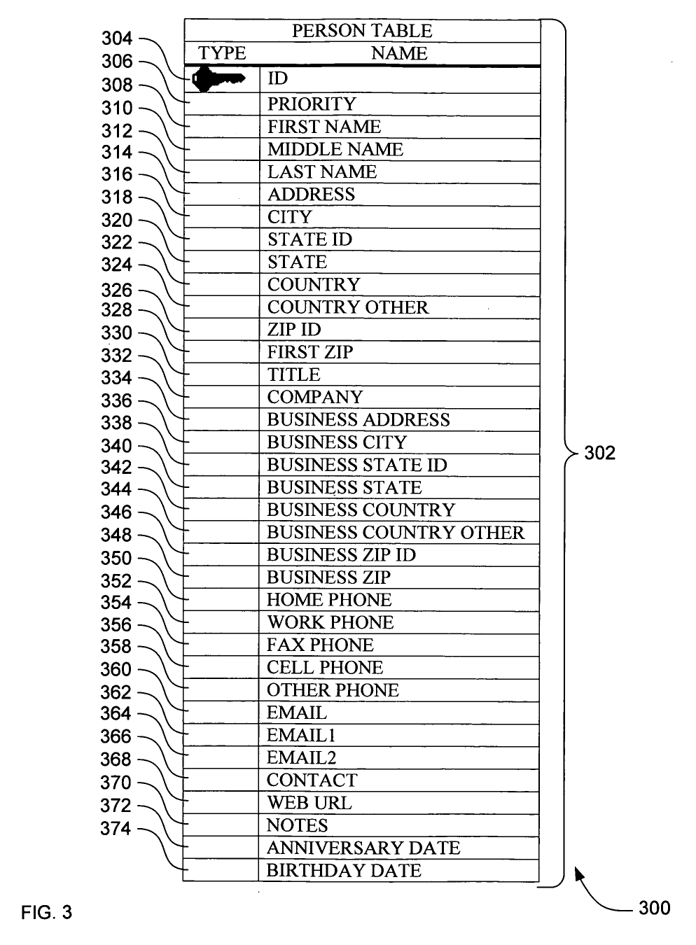

FIG. 3 is a diagram of a table layout data structure 300 to manage persons.

Table layout data structure 300 includes a table representing persons 302. Each record of the persons table 302 includes an indexed key field representing an identification of a person 304.

Other embodiments of the persons table 302 include any combination of the following: A field representing a priority 306 of the person, a field representing a first name 308 of the person, a field representing a middle name 310 of the person, a field representing a last name 312 of the person, a field representing an address 314 of the person, a field representing a city 316 of the person, a field representing a state identification 318 of the person, a field representing a state 320 of the person, a field representing a country 322 a field representing a country other 324 of the person, a field representing a zip code identification 326 of the person, a field representing a zip code 328 of the person, a field representing a title 330 of the person, a field representing a company name 332 of the person, a field representing a business address 334 of the person, a field representing a business city 336 of the person, a field representing a business state identification 338 of the person, a field representing a business state 340 of the person, a field representing a business country 342 of the person, a field representing a business country other 344 of the person, a field representing a business zip code identification 346 of the person, a field representing a business zip code 348 of the person, a field representing a home phone 350 of the person, a field representing a work phone 352 of the person, a field representing a fax number 354 of the person, a field representing a cell phone number 356 of the person, a field representing an other phone 358 of the person, a field representing a first email address 360 of the person, a field representing a second email address 362 of the person, a field representing a third email address 364 of the person, a field representing a contact 366 of the person, a field representing an Internet URL 368 of the person, a field representing a notes 370 of the person, a field representing an anniversary date 372 and a field representing a birthday date 374.

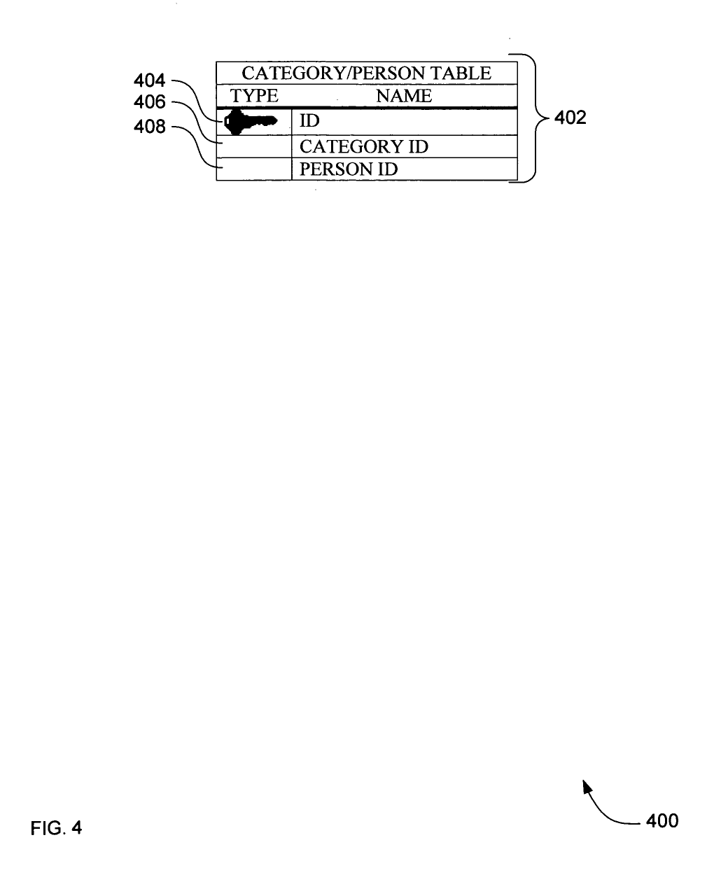

FIG. 4 is a diagram of a table layout data structure 400 to manage category and person relationships.

Table layout data structure 400 includes a table representing category/person relationships 402. Each record of the category/person table 402 includes an indexed key field representing an identification of category/person 404, a field representing a description of the category identification 406 and a text field representing a person identification 408. The table layout data structure 400 that includes a table representing category/persons 402 provides a relationship between categories and persons.

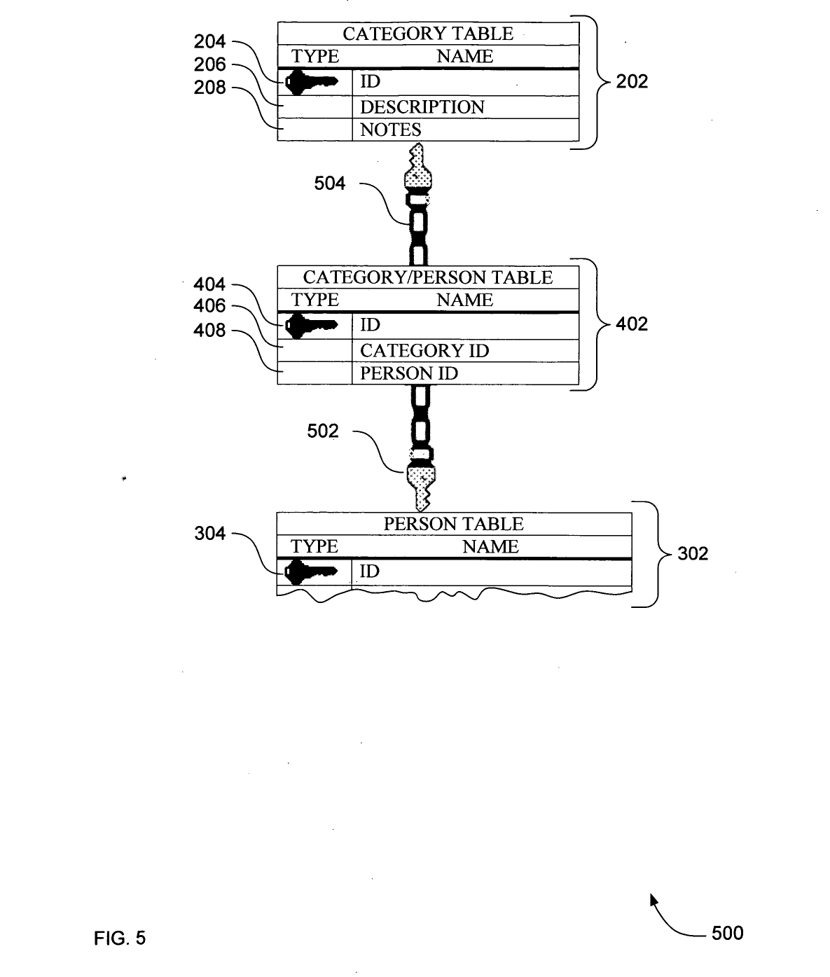

FIG. 5 is a diagram of a data structure 500 to manage category and person relationships.

Table layout data structure 500 includes a table representing categories 202, a table representing persons 302 and a table representing category and person relationships 402. The category/person relationships table 402 provides a path through which persons are associated with category data. The persons table 302 has a one-to-many relationship with the category/person relationships table 402 as indicated by the connection 502 and the category table 202 has one-to-many relationship with the category/person relationships table 402 as indicated by the connection 504.

In table layout data structure 500, the category/person relationships table 402 acts an intermediary table that provides many-to-many associations between the categories table 202 and the persons table. This provides a many-to-many relationship between persons and categories. Any person, and any number of persons, can be associated with any category or any number of categories.

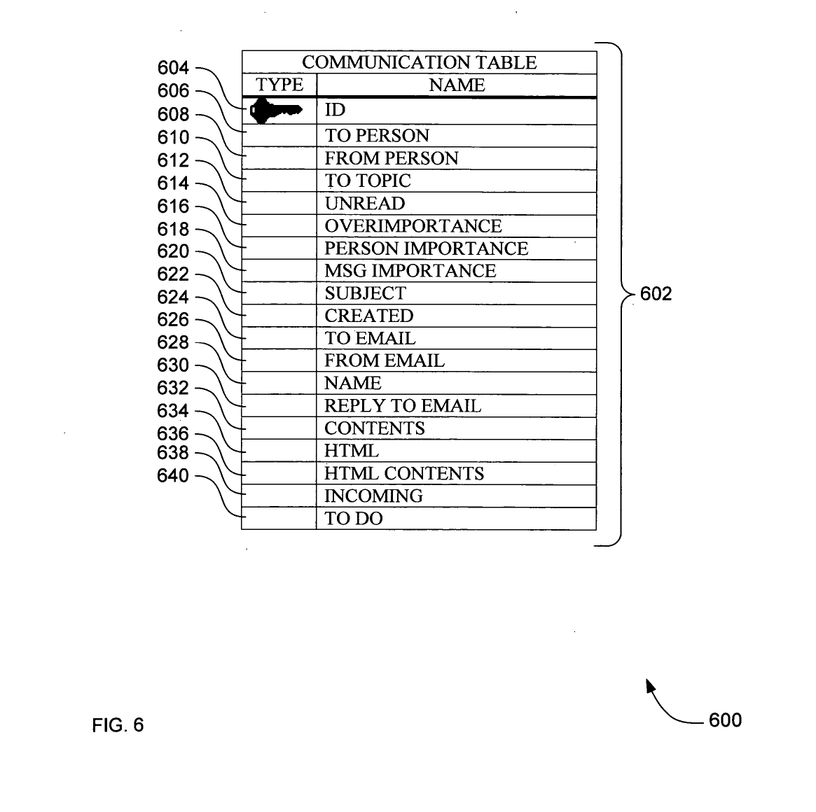

FIG. 6 is a diagram of a table layout data structure 600 to manage communications. In some embodiments, the communication is an email communication.

Table layout data structure 600 includes a table representing communications 602. Each record of the communication table 602 includes an indexed key field representing an identification of a communication 604, a field representing a identification of a person to whom the communication was sent 606, a field representing an identification of a person from whom the communication was sent 608, a field representing a topic of the communication 610, a field representing a read/unread status of the communication 612, a field representing an over importance of the communication 614, a field representing an importance of the person of the communication 616, a field representing an importance of the communication 618, a field representing a subject of the communication 620, a field representing a creation date the communication 622, a field representing a “to” email address of the communication 624, a field representing a “from” email address of the communication 626, a field representing a name of the communication 628, a field representing a reply address of the communication 630, a field representing a contents or body of the communication 632, a field representing a HTML status of the communication 634, a field representing a HTML contents status of the communication 636, a field representing an incoming status of the communication 638, and a field representing a “to do” status of the communication 640. The contents field 632 stores the text of the body of the email communication. The HTML contents 636 stores the HTML tags and text of the email communication.

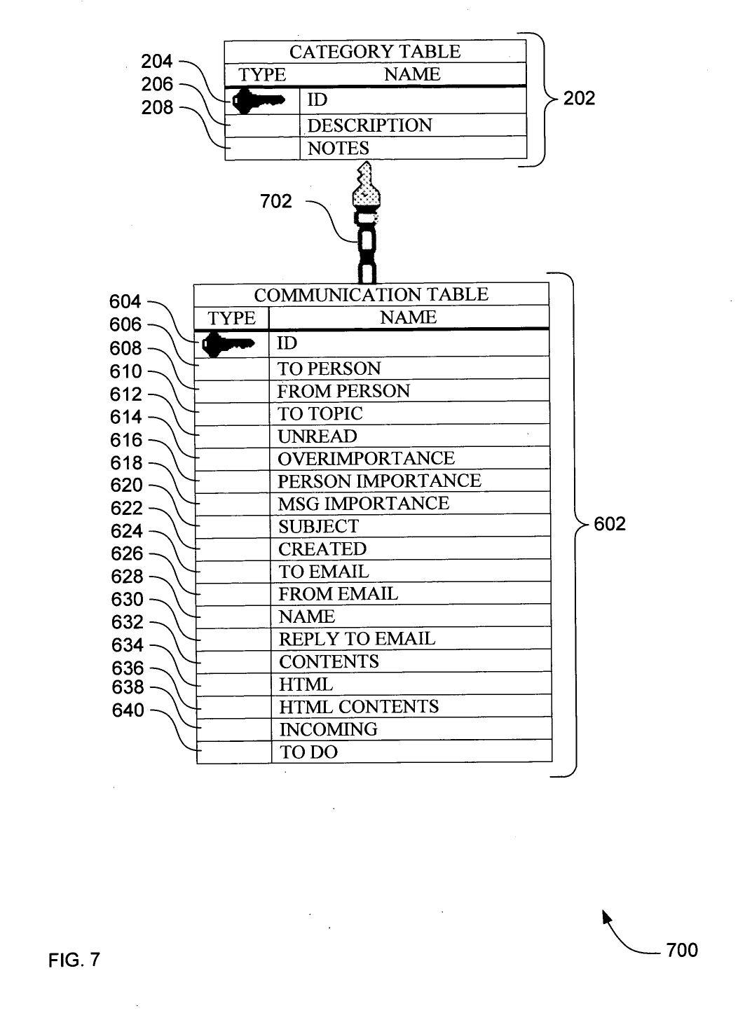

FIG. 7 is a diagram of a data structure 700 to manage category and communications relationships.

Table layout data structure 700 includes a table representing categories 202, and a table representing communications 602. The category table 202 has a one-to-many relationship with the communications table 602 as indicated by the connection 702.

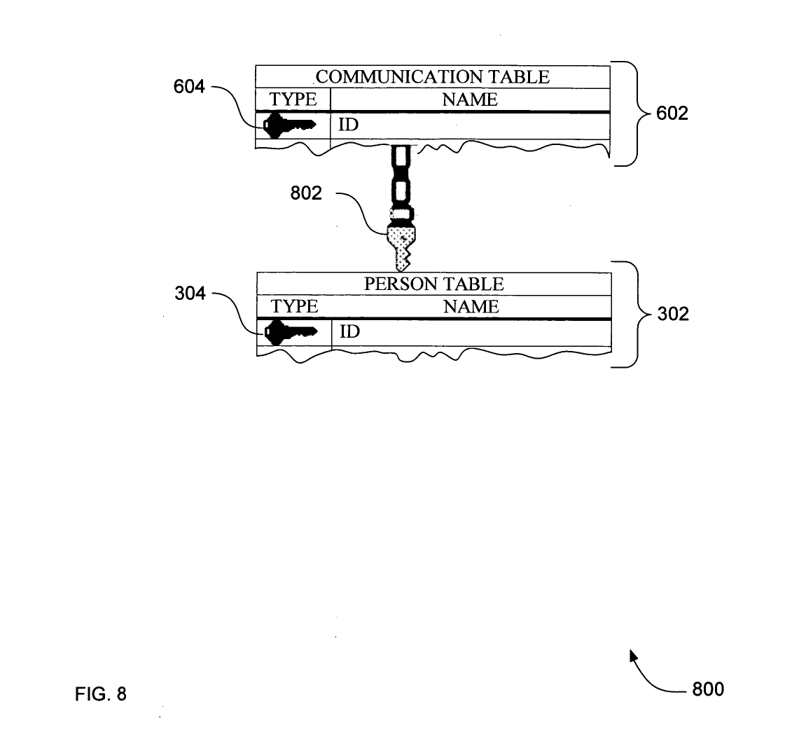

FIG. 8 is a diagram of a data structure 800 to manage persons and communications relationships.

Table layout data structure 800 includes a table representing persons 302, and a table representing communications 602. The persons table 302 has a one-to-many relationship with the communications table 602 as indicated by the connection 802.

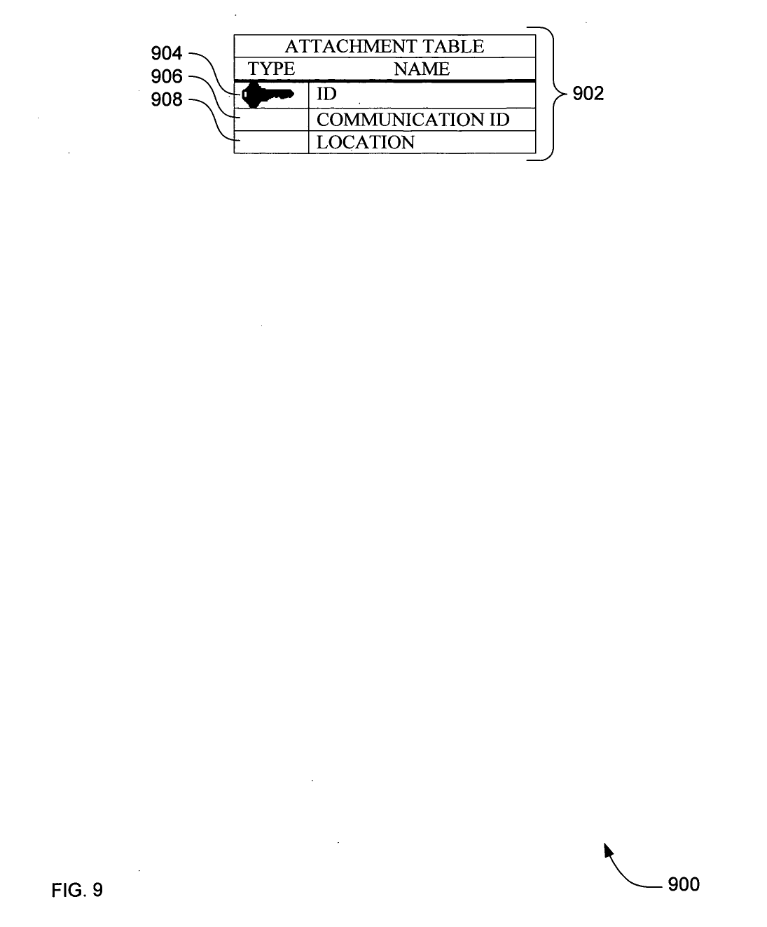

FIG. 9 is a diagram of a table layout data structure 900 to manage attachments. Table layout data structure 900 solves the need in the art for more storage of email data including attachments, without having to resort to archival files.

Table layout data structure 900 includes a table representing attachments 902. Each record of the attachments table 902 includes an indexed key field representing an identification of an attachment 904, a text field representing a communication identification 906 and a field representing a location of the attachment 908. In some embodiments, the communication is an email. In some embodiments, the location 908 is a full path name such as “C:\\USERFILES\ATTACHMENT04340.DOC”.

In some embodiments, the location 908 is outside the email database. The attachments table 902 provides a means to locate attachments that are stored separately from the email database. Thus the attachments table 900 supports storage of attachments outside of the email database, which allows the only the emails to be stored in the email database, which in turn reduces, if not eliminates, the amount of storage in the email database required to store attachments. This allows many more emails to be stored in the email database and the attachments to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the attachments in the unused hard disk space separately from the email database not only provides a means to make the much larger amount of unused disk space available to store attachments, but also provides a means to use the email database only for emails, which allows more emails to be stored in the email database. Thus attachment table 900 solves the need in the art for more storage for email data including attachments, without having to resort to archival files.

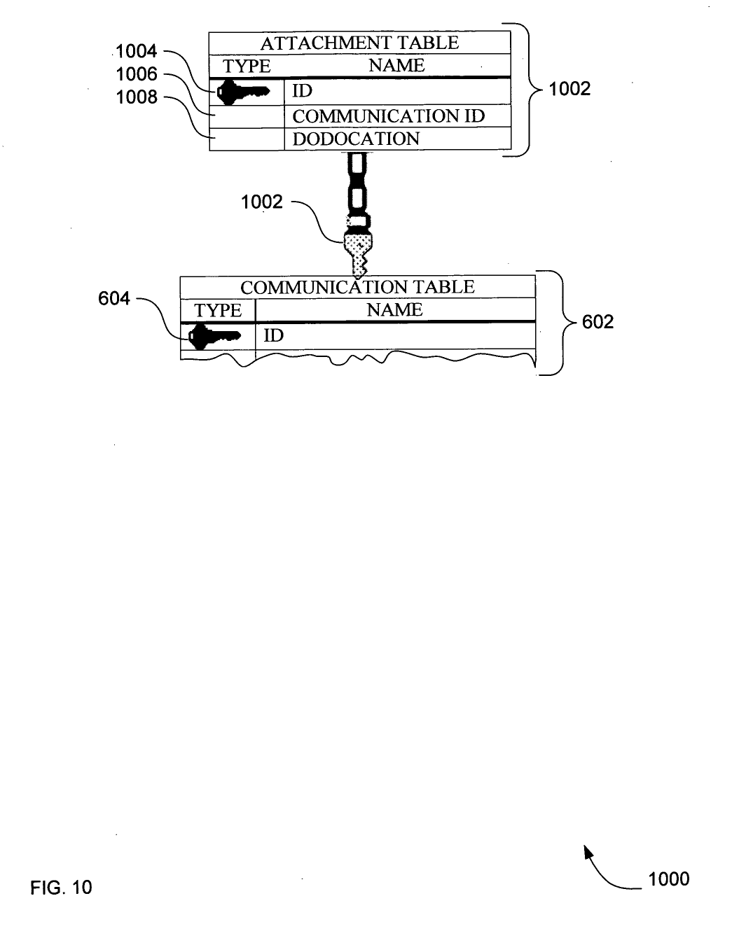

FIG. 10 is a diagram of a data structure 1000 to manage communications and attachment relationships.

Table layout data structure 1000 includes a table representing attachments 902, and a table representing communications 602. The communications table 602 has a one-to-many relationship with the attachments table 902 as indicated by the connection 1002.

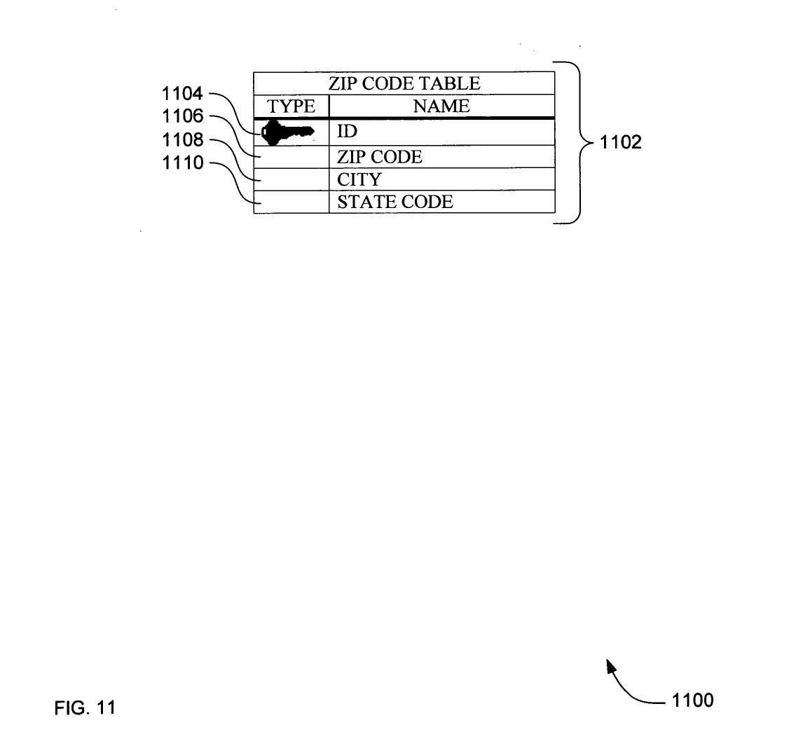

FIG. 11 is a diagram of a table layout data structure 1100 to manage zip codes.

Table layout data structure 1100 includes a table representing zip codes 1102. Each record of the zip code table 1102 includes an indexed key field representing an identification of a zip code 1104, a field representing a zip code 1106, a field representing a city of the zip code and a field representing state of the zip code 1110.

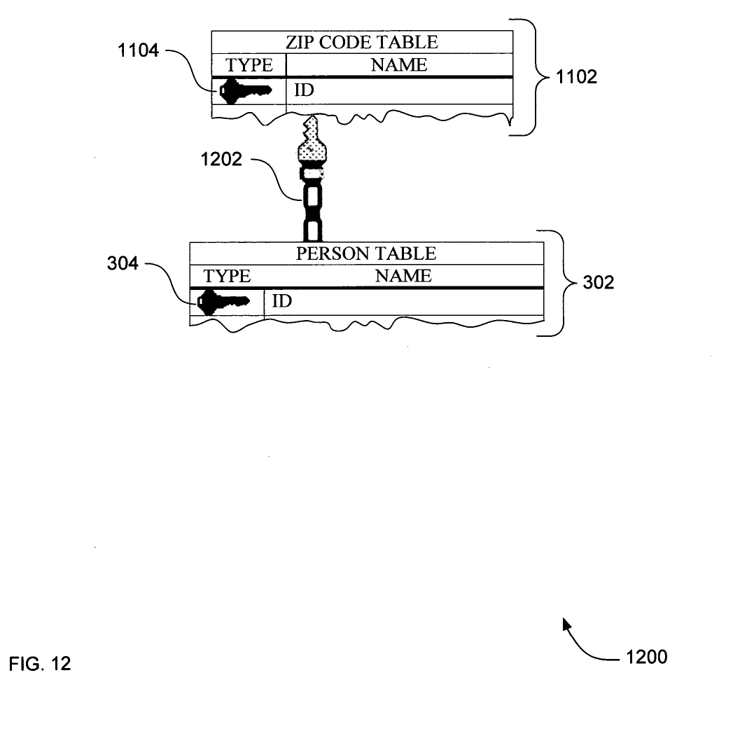

FIG. 12 is a diagram of a data structure 1200 to manage persons and zip code relationships.

Table layout data structure 1200 includes a table representing persons 302, and a table representing zip codes 1102. The zip code table 1102 has a one-to-many relationship with the persons table 302 as indicated by the connection 1202.

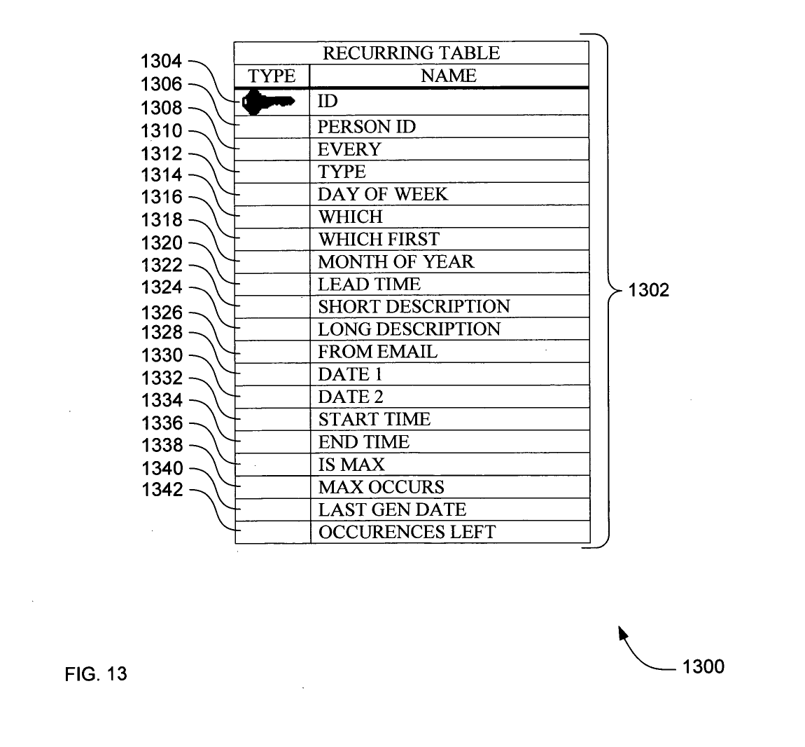

FIG. 13 is a diagram of a table layout data structure 1300 to manage recurrences.

Table layout data structure 1300 includes a table representing recurrences 1302. Each record of the recurring table 1302 includes an indexed key field representing an identification of a recurrence 1304.

Other embodiments of the recurring table 1302 include any combination of the following: A field representing a person identification 1306, a field representing a period of recurrence 1308, a field representing a type of recurrence 1310, a field representing a day of the week of the recurrence 1312, a field representing a which of the recurrence 1314, a field representing a which first of the recurrence 1316, a field representing a month of the recurrence 1318, a field representing a lead time of the recurrence 1320, a field representing a short description of the recurrence 1322, a field representing a long description of the recurrence 1324, a field representing a from email address of the recurrence 1326, a field representing a first date of the recurrence 1328, a field representing a second date of the recurrence 1330, a field representing a start time of the recurrence 1332, a field representing an end time of the recurrence 1334, a field representing a maximum status of the recurrence 1336, a field representing a maximum occurrences of the recurrence 1338, a field representing a last date that the occurrence was generated 1340, and a field representing a number of remaining occurrences 1342.

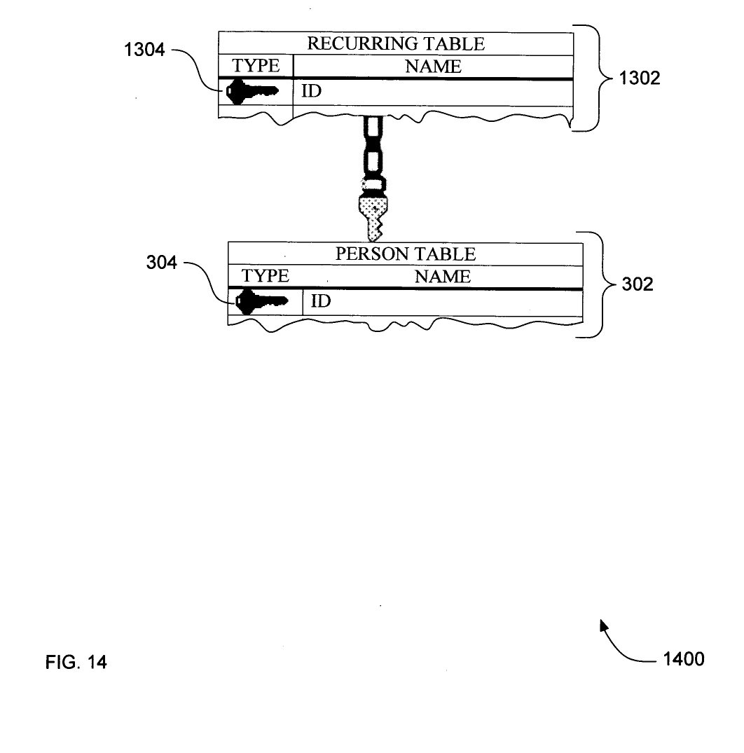

FIG. 14 is a diagram of a data structure 1400 to manage persons and recurrences relationships.

Table layout data structure 1400 includes a table representing persons 302, and a table representing recurrences 602. The persons table 302 has a one-to-many relationship with the recurrences table 602 as indicated by the connection 1402.

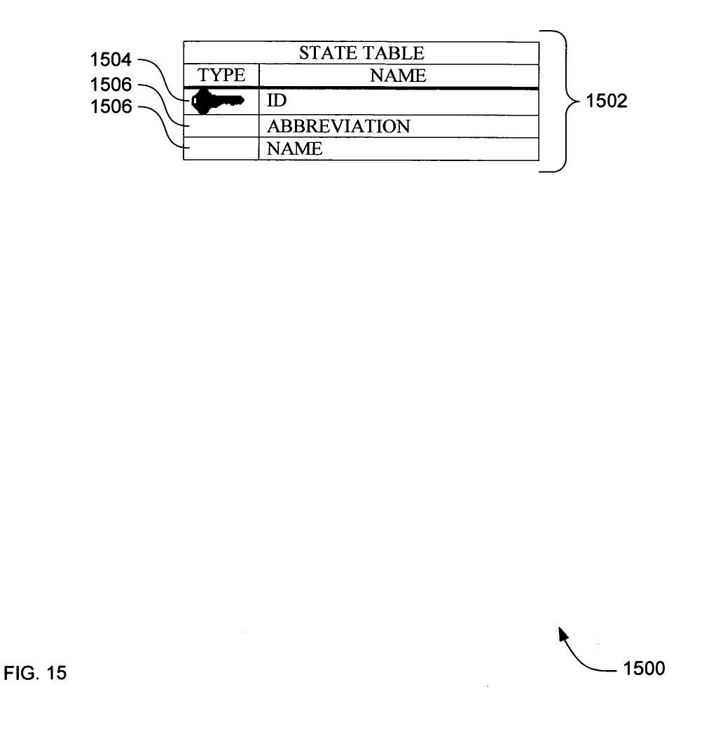

FIG. 15 is a diagram of a table layout data structure 1500 to manage states.

Table layout data structure 1500 includes a table representing states 1502. Each record of the states table 1502 includes an indexed key field representing an identification of a state 1504, a text field representing an abbreviation of the state 1506 and a field representing a name of the state 1508.

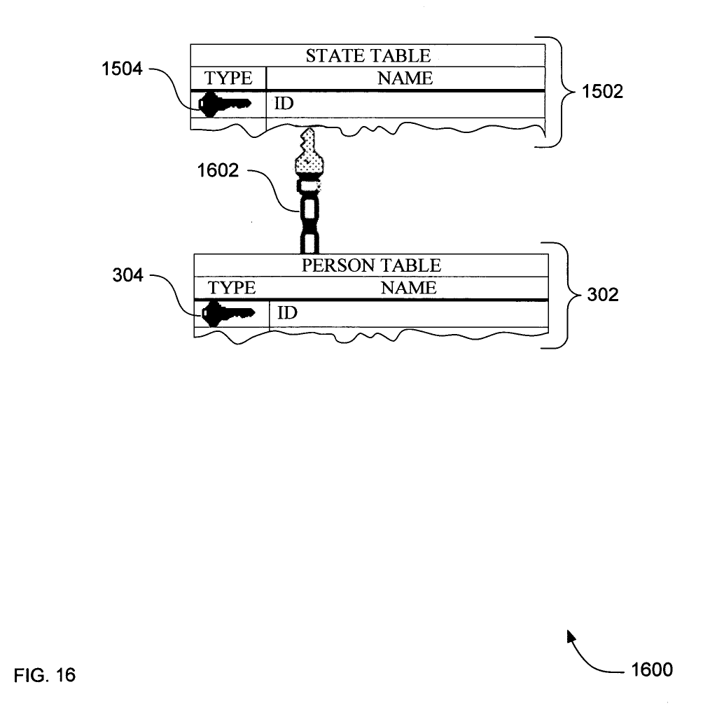

FIG. 16 is a diagram of a data structure 1600 to manage persons and state relationships.

Table layout data structure 1600 includes a table representing persons 302, and a table representing states 1502. The state table 1502 has a one-to-many relationship with the persons table 302 as indicated by the connection 1602.

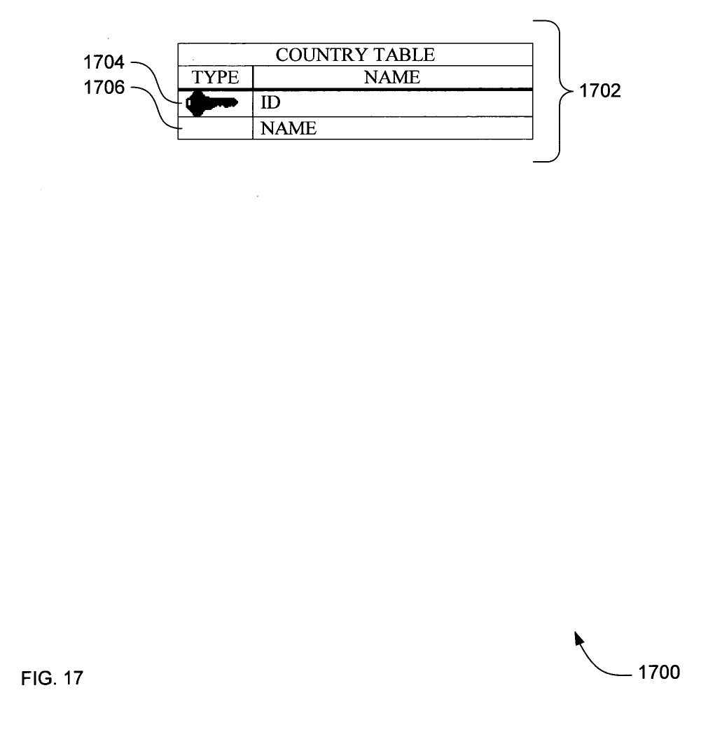

FIG. 17 is a diagram of a table layout data structure 1700 to manage countries.

Table layout data structure 1700 includes a table representing countries 1702. Each record of the country table 1702 includes an indexed key field representing an identification of a country 1704, and a field representing a name of the country 1706.

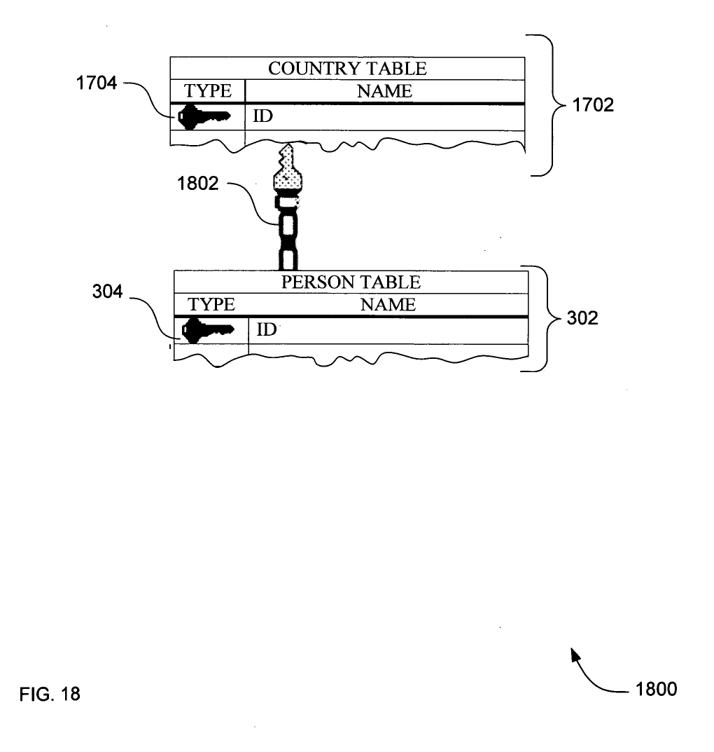

FIG. 18 is a diagram of a data structure 1800 to manage persons and country relationships.

Table layout data structure 1800 includes a table representing persons 302, and a table representing countries 1702. The country table 1702 has a one-to-many relationship with the persons table 302 as indicated by the connection 1802.

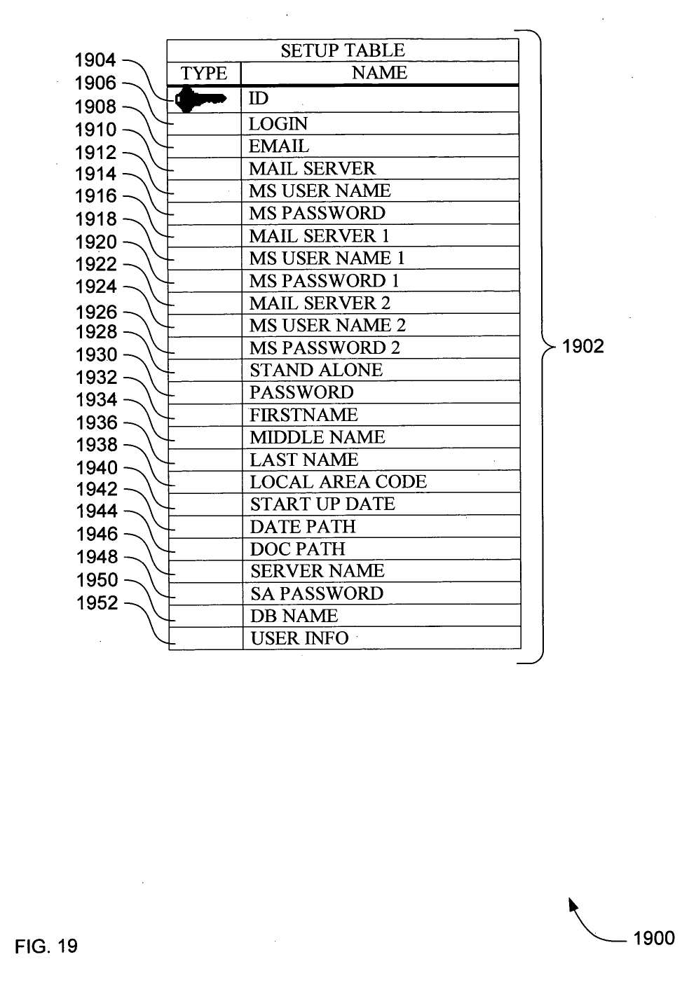

FIG. 19 is a diagram of a table layout data structure 1900 to manage setups.

Table layout data structure 1900 includes a table representing setups 1902. Each record of the setup table 1902 includes an indexed key field representing an identification of a setup 1904.

Other embodiments of the setup table 1902 include any combination of the following: A field representing a login 1906, a field representing an email address 1908, a field representing a first mail server 1910, a field representing a first Microsoft user name 1912, a field representing a first Microsoft password 1914, a field representing a second mail server 1916, a field representing a second Microsoft user name 1918, a field representing a second Microsoft password 1920, a field representing a third mail server 1922 a field representing a third Microsoft user name 1924, a field representing a third Microsoft password 1926, a field representing a standalone status 1928, a field representing a password 1930, a field representing a first name 1932, a field representing a middle name 1934, a field representing a last name 1936, a field representing a local area code 1938, a field representing a start up date 1940, a field representing a date path 1942, a field representing a document path 1944, a field representing a server name 1946, a field representing a super administrator (SA) password 1948, a field representing a database name 1950, and a field representing user information 1952.

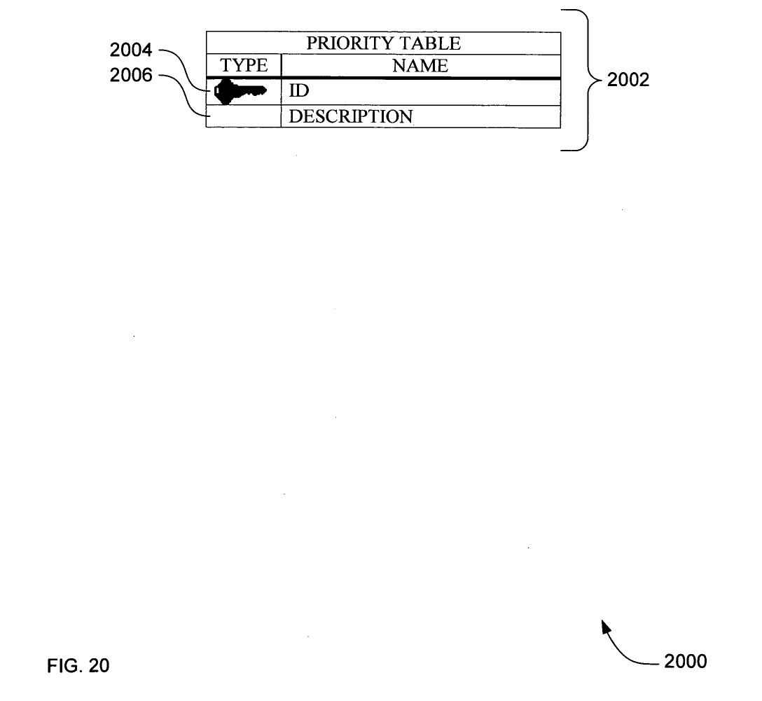

FIG. 20 is a diagram of a table layout data structure 2000 to manage priorities.

Table layout data structure 2000 includes a table representing priorities 2002. Each record of the priority table 2002 includes an indexed key field representing an identification of a priority 2004, and a field representing a description of the priority 2006.

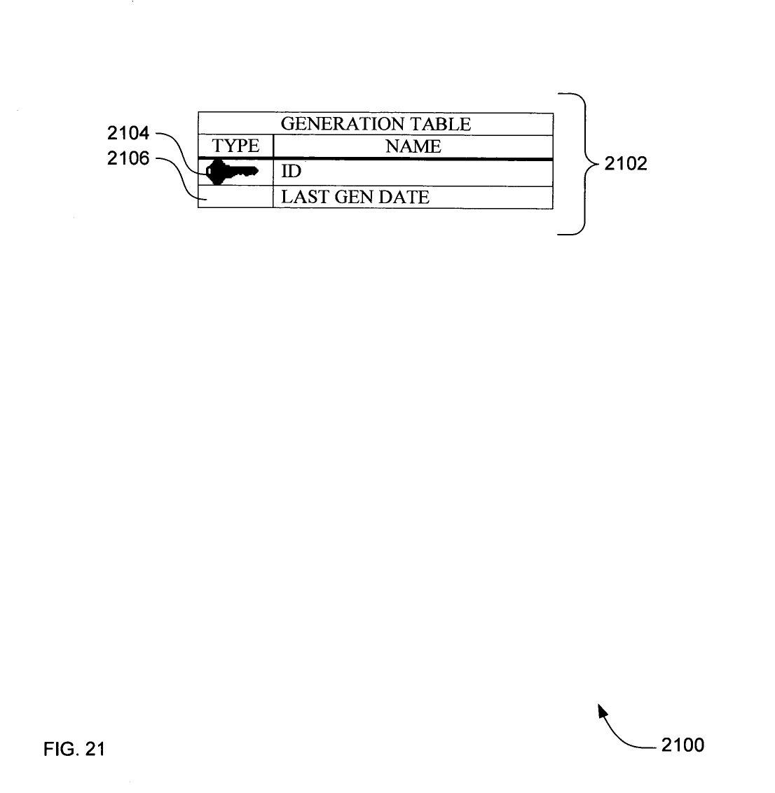

FIG. 21 is a diagram of a table layout data structure 2100 to manage generations.

Table layout data structure 2100 includes a table representing generations 2102. Each record of the priority table 2102 includes an indexed key field representing an identification of a generation 2104, and a field representing a late generation date of the priority 2106.

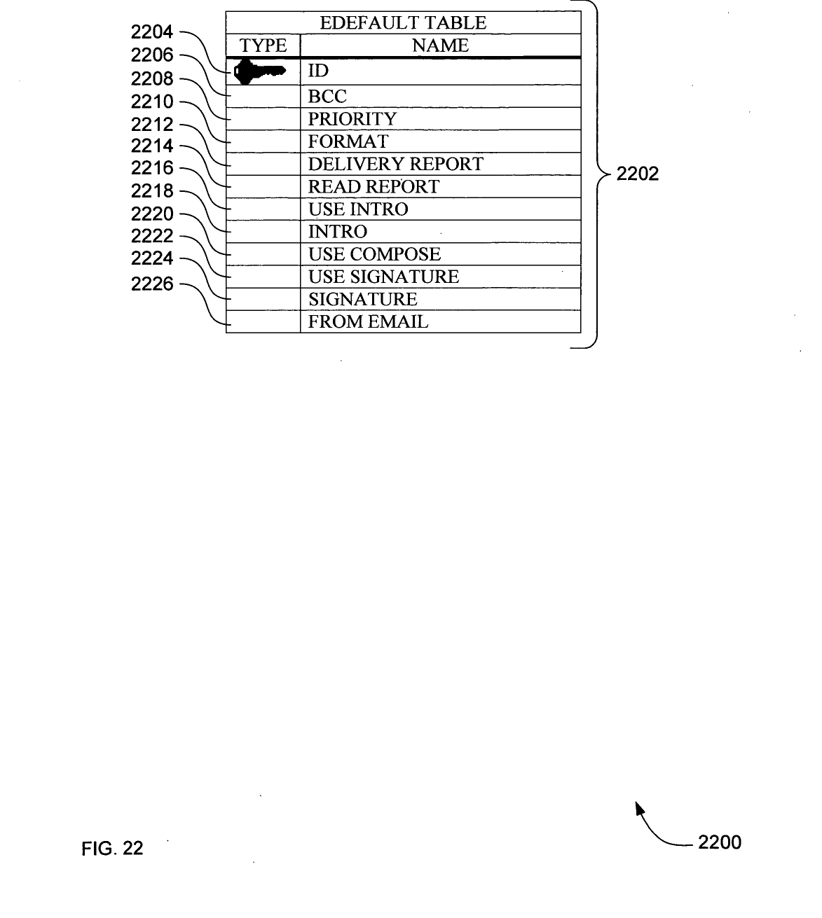

FIG. 22 is a diagram of a table layout data structure 2200 to manage email sending defaults (edefaults).

Table layout data structure 2200 includes a table representing edefaults 2202. Each record of the edefaults table 2202 includes an indexed key field representing an identification of an edefault 2204.

Other embodiments of the edefaults table 2202 include any combination of the following: A field representing a blind-carbon-copy (BCC) 2206, a field representing a priority of the edefault 2208, a field representing a format of the edefault 2210, a field representing a delivery report 2212, a field representing a read report 2214, a field representing a use introduction 2216, a field representing an introduction 2218, a field representing a use compose 2220, a field representing a use signature 2222 a field representing a signature 2224, and a field representing a from email address 2226.

FIG. 23 is a diagram of a table layout data structure 2300 to manage contacts.

Table layout data structure 2300 includes a table representing contacts 2302. Each record of the contacts table 2302 includes an indexed key field representing an identification of a contact 2304.

Other embodiments of the contacts table 2302 include any combination of the following: A field representing a first name 2306, a field representing a last name of the contact 2308, a field representing a middle name of the contact 2310, a field representing a name 2312, a field representing an email address 2314, a field representing an address 2316, a field representing a street 2318, a field representing a city 2320, a field representing a zip code 2322 a field representing a state 2324, and a field representing a region 2326.

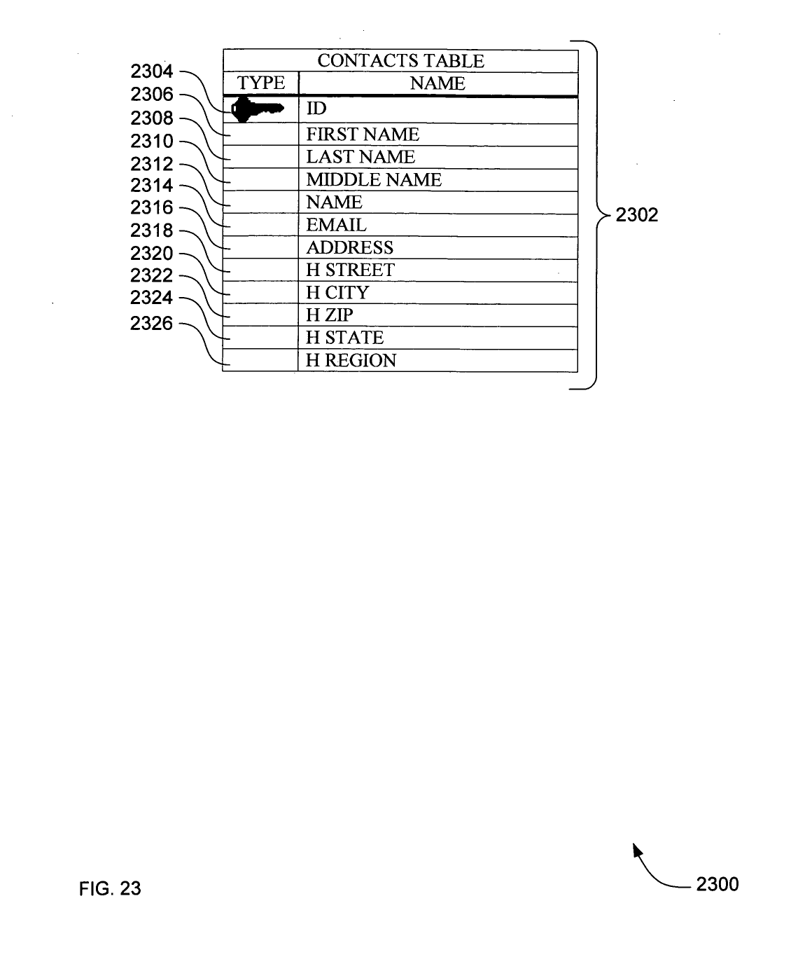

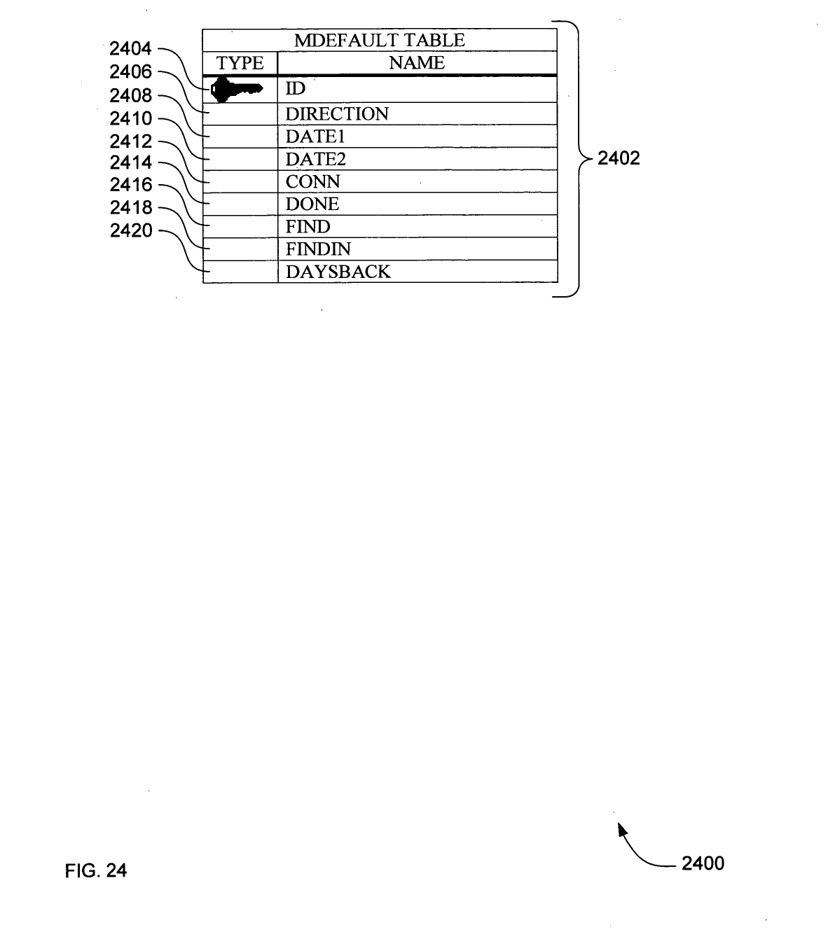

FIG. 24 is a diagram of a table layout data structure 2400 to manage email receiving defaults (mdefaults).

Table layout data structure 2400 includes a table representing mdefaults 2402. Each record of the mdefaults table 2402 includes an indexed key field representing an identification of a mdefault 2404.

Other embodiments of the mdefaults table 2402 include any combination of the following: A field representing a direction 2406, a field representing a first date of the mdefault 2408, a field representing a second date of the mdefault 2410, a field representing a connection 2412, a field representing a done status 2414, a field representing a find status 2416, a field representing a findin status 2418, and a field representing days back 2420.

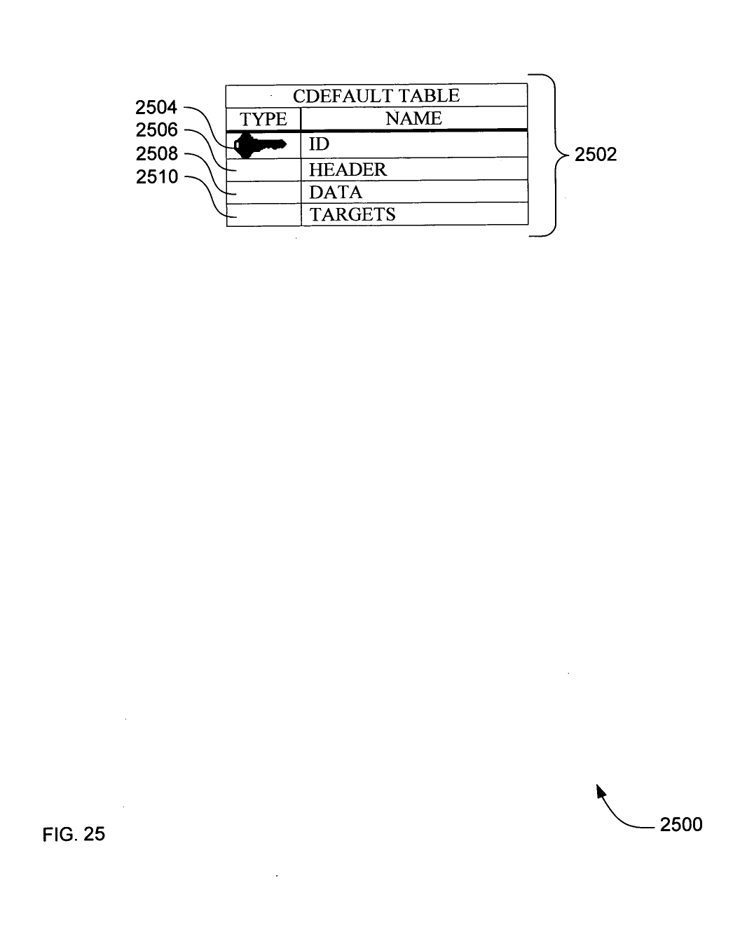

FIG. 25 is a diagram of a table layout data structure 2500 to manage contact defaults (cdefaults).

Table layout data structure 2500 includes a table representing contact default information 2502. Each record of the contact default table 2502 includes an indexed key field representing an identification of a contact default 2504, a field representing a contact default header 2506, a field representing data of the contact default and a field representing at least one target of the contact default 2510.

### Database Manager Implementation

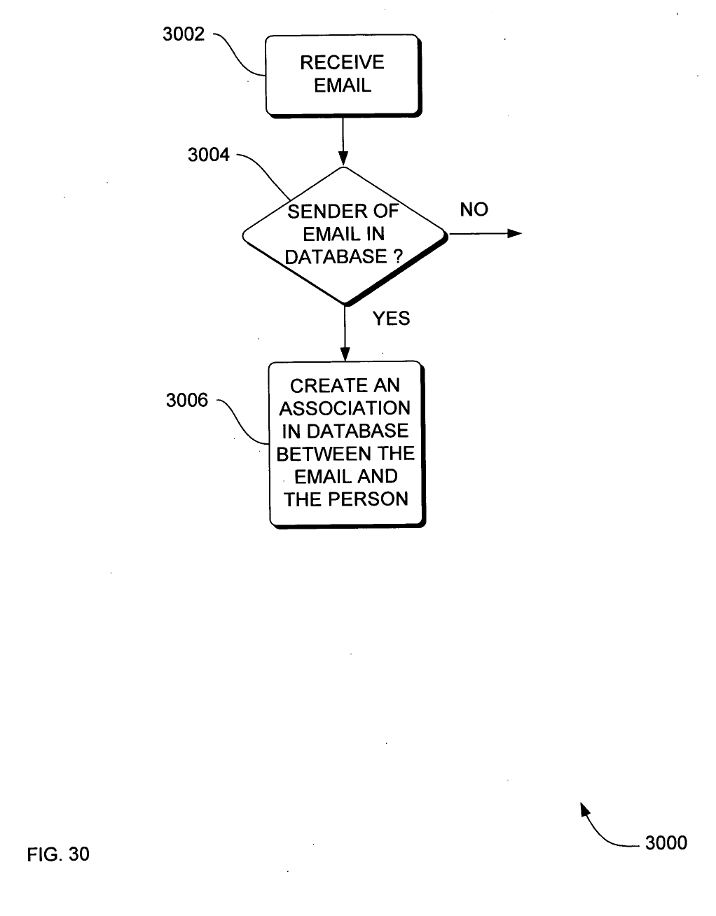

Referring to FIGS. 26-28, particular implementations of database managers and data architectures are described in conjunction with the system overview in FIG. 1 and the methods described in conjunction with FIGS. 30-41

FIG. 26 is a block diagram of a data storage architecture 2600 that provides a stable data storage environment through a transaction-based architecture. In a transaction-based database manager, a bifurcated file structure improves data integrity.

Transactions 2602 are stored separately from the database 2604 which allows the transactions 2602 to be backed up separately from the database 2604. The separate data storage locations provide the bifurcated structure. This reduces the chance that corruption in the database 2604 will affect the transactions 2602. When the database 2604 becomes corrupted, a backup copy (not shown) of that database 2604 is restored, and then the transactions 2602 are applied to the database 2604 by a transaction-based database manager 2606, bringing the database 2604 to a fully updated state. In other embodiments, the transactions 2602 are rolled back from the corrupted database 2604 by the transaction-based database manager 2604. Thus the state of the database 2604 is returned to a state prior to the corruption. The ability to back out transactions 2602 and update the database 2604 with transactions 2602 greatly reduces the chance that data will be permanently lost, which improves data integrity of the database 2604.

Apparatus 2600 solves the need in the art to improve data integrity, and thus operational stability of an email client that accesses the data storage architecture 2600.

FIG. 27 is a block diagram of a database manager 2700 that provides a stable data storage environment through a high level security manager.

Database manager 2700 includes a high level security manager 2702 that ensures that data is written to appropriate portions of a database (not shown), and only to appropriate portions of the database, and also ensures that the data is written only under required authorizations. This reduces the chances of corruption of the database, which improves data integrity of the database.

FIG. 28 is a block diagram of a database manager 2800 that provides a stable data storage environment through relational data management. The relational database manager 2800 is adapted to operate in conjunction with tables, such as tables 200-2500.

Apparatus components can be embodied as computer hardware circuitry or as a computer-readable program, or a combination of both. In another embodiment, the systems, methods and apparatus are implemented in an application service provider (ASP) system.

More specifically, in the computer-readable program embodiment, the programs can be structured in managed or unmanaged code, or in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 2902 in FIG. 29, or on at least as many computers as there are components.

### Hardware and Operating Environment

FIG. 29 is a block diagram of a hardware and operating environment 2900 in which different embodiments can be practiced. The description of FIG. 29 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 2902 includes a processor 2904, commercially available from Intel, Motorola, Cyrix and others. Computer 2902 also includes random-access memory (RAM) 2906, read-only memory (ROM) 2908, and one or more mass storage devices, 2910, and a system bus 2912, that operatively couples various system components to the processing unit 2904. The memory 2906, 2908, and mass storage devices, 2910, are types of computer-accessible media. Mass storage devices 2910 are more specifically types of nonvolatile computer-accessible media and can include one or more hard disk drives, floppy disk drives, optical disk drives, and tape cartridge drives. The processor 2904 executes computer programs stored on the computer-accessible media.

Computer 2902 can be communicatively connected to the Internet 2914 via a communication device 2916. Internet 2914 connectivity is well known within the art. In one embodiment, a communication device 2916 is a modem that responds to communication drivers to connect to the Internet via what is known in the art as a “dial-up connection.” In another embodiment, a communication device 2916 is an Ethernet® or similar hardware network card connected to a local-area network (LAN) that itself is connected to the Internet via what is known in the art as a “direct connection” (e.g., T1 line, etc.).

A user enters commands and information into the computer 2902 through input devices such as a keyboard 2918 or a pointing device 2920. The keyboard 2918 permits entry of textual information into computer 2902, as known within the art, and embodiments are not limited to any particular type of keyboard. Pointing device 2920 permits the control of the screen pointer provided by a graphical user interface (GUI) of operating systems such as versions of Microsoft Windows®. Embodiments are not limited to any particular pointing device 2920. Such pointing devices include mice, touch pads, trackballs, remote controls and point sticks. Other input devices (not shown) can include a microphone, joystick, game pad, satellite dish, scanner, or the like.

In some embodiments, computer 2902 is operatively coupled to a display device 2922. Display device 2922 is connected to the system bus 2912. Display device 2922 permits the display of information, including computer, video and other information, for viewing by a user of the computer. Embodiments are not limited to any particular display device 2922. Such display devices include cathode ray tube (CRT) displays (monitors), as well as flat panel displays such as liquid crystal displays (LCD's). In addition to a monitor, computers typically include other peripheral input/output devices such as printers (not shown). Speakers 2924 and 2926 provide audio output of signals. Speakers 2924 and 2926 are also connected to the system bus 2912.

Computer 2902 also includes an operating system (not shown) that is stored on the computer-accessible media RAM 2906, ROM 2908, and mass storage device 2910, and is and executed by the processor 2904. Examples of operating systems include Microsoft Windows®, Apple MacOS®, Linux®, UNIX®. Examples are not limited to any particular operating system, however, and the construction and use of such operating systems are well known within the art.

Embodiments of computer 2902 are not limited to any type of computer 2902. In varying embodiments, computer 2902 comprises a PC-compatible computer, a MacOS®-compatible computer, a Linux®-compatible computer, or a UNIX®-compatible computer. The construction and operation of such computers are well known within the art.

Computer 2902 can be operated using at least one operating system to provide a graphical user interface (GUI) including a user-controllable pointer. Computer 2902 can have at least one web browser application program executing within at least one operating system, to permit users of computer 2902 to access an intranet, extranet or Internet world-wide-web pages as addressed by Universal Resource Locator (URL) addresses. Examples of browser application programs include Netscape Navigator® and Microsoft Internet Explorer®.

The computer 2902 can operate in a networked environment using logical connections to one or more remote computers, such as remote computer 2928. These logical connections are achieved by a communication device coupled to, or a part of, the computer 2902. Embodiments are not limited to a particular type of communications device. The remote computer 2928 can be another computer, a server, a router, a network PC, a client, a peer device or other common network node. The logical connections depicted in FIG. 29 include a local-area network (LAN) 2930 and a wide-area network (WAN) 2932. Such networking environments are commonplace in offices, enterprise-wide computer networks, intranets, extranets and the Internet.

When used in a LAN-networking environment, the computer 2902 and remote computer 2928 are connected to the local network 2930 through network interfaces or adapters 2934, which is one type of communications device 2916. Remote computer 2928 also includes a network device 2936. When used in a conventional WAN-networking environment, the computer 2902 and remote computer 2928 communicate with a WAN 2932 through modems (not shown). The modem, which can be internal or external, is connected to the system bus 2912. In a networked environment, program modules depicted relative to the computer 2902, or portions thereof, can be stored in the remote computer 2928.

Computer 2902 also includes power supply 2938. Each power supply can be a battery.

### Method Embodiments

In the previous section, table layouts are described. In this section, the particular methods and dataflow diagrams of such embodiments are described by reference to a series of flowcharts. Describing the methods by reference to a flowchart and dataflow diagrams enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 3000-4100 are performed by a program executing on, or performed by firmware or hardware that is a part of, a computer, such as computer 2902 in FIG. 29.

FIG. 30 is a flowchart of a method 3000 to manage email associations, according to an embodiment.

Method 3000 includes receiving an email 3002 and determining 3004 whether or not the sender of the email is in a database. In some embodiments, the determination is performed by comparing a sender email address contained in the email to a table in a database, such as the person table 300 in FIG. 3. For example, the fields EMAIL 360, EMAIL1 360 and/or EMAIL3 364 in the person table 300 in FIG. 3 can be compared to the sender's email address to determine if the sender is in the database.

If the sender of the email is in the database, then a connection is created 3006 in the database between email and the person.

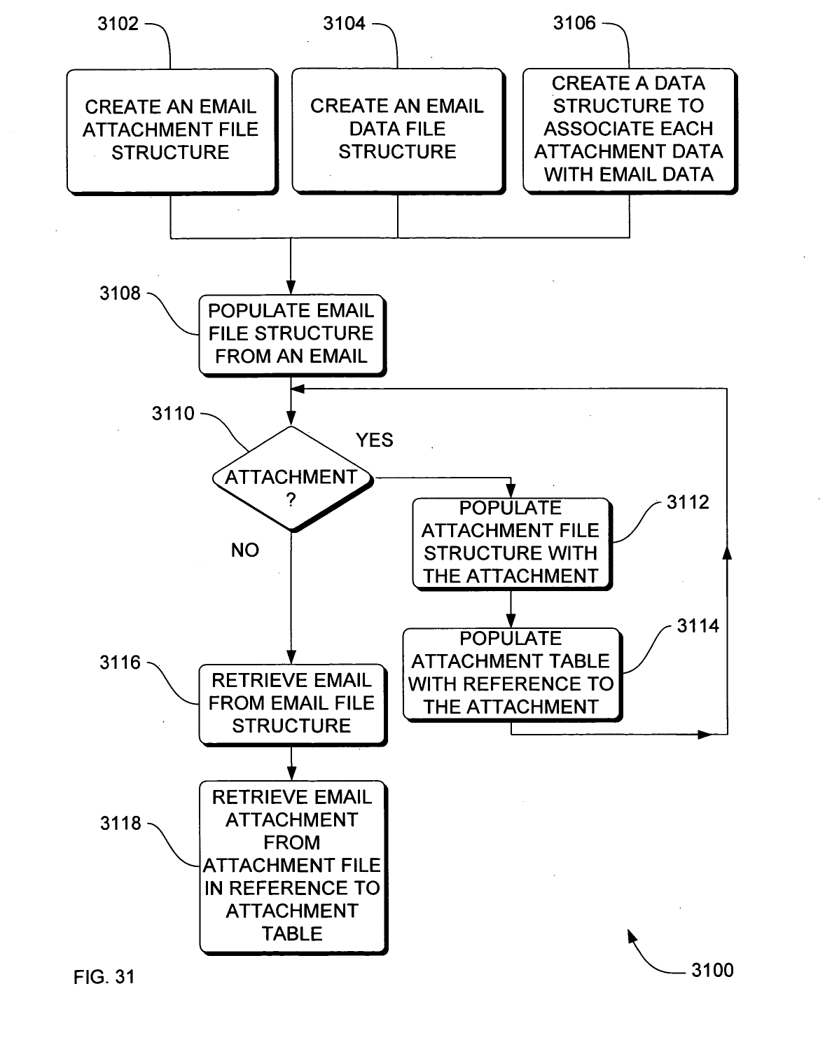

FIG. 31 is a flowchart of a method 3100 to provide storage for email data including attachments according to an embodiment. Method 3100 solves the need in the art for more storage of email data including attachments, without having to resort to archival files.

Method 3100 includes creating 3102 a file structure that is operable to store email attachment data. In some embodiments, that email attachment file structure is a file stored on a disk drive of a computer performing method 3100.

Method 3100 also includes creating 3104 a file structure that is operable to store email data other than the email attachment data. One such data structure created by action 3104 is a record in the communication table 602 in FIG. 6 above.

Method 3100 further includes creating 3106 a data structure that is operable to associate each attachment data with an email data. One such data structure created by action 3106 is a record in the attachment table 902 in FIG. 9 above.

Thereafter, method 3100 includes populating 3108 the file structure that is operable to store email data other than the email attachment data with an email data file other than email attachment data.

If the email includes an attachment 3110, then method 3100 includes populating 3112 the file structure that is operable to store email attachment data with the email attachment file and populating 3114 the attachment table 900 with an entry related to the email attachment file in the email attachment file structure. Actions 3110-3114 are repeated for as many attachments that are associated with the email data.

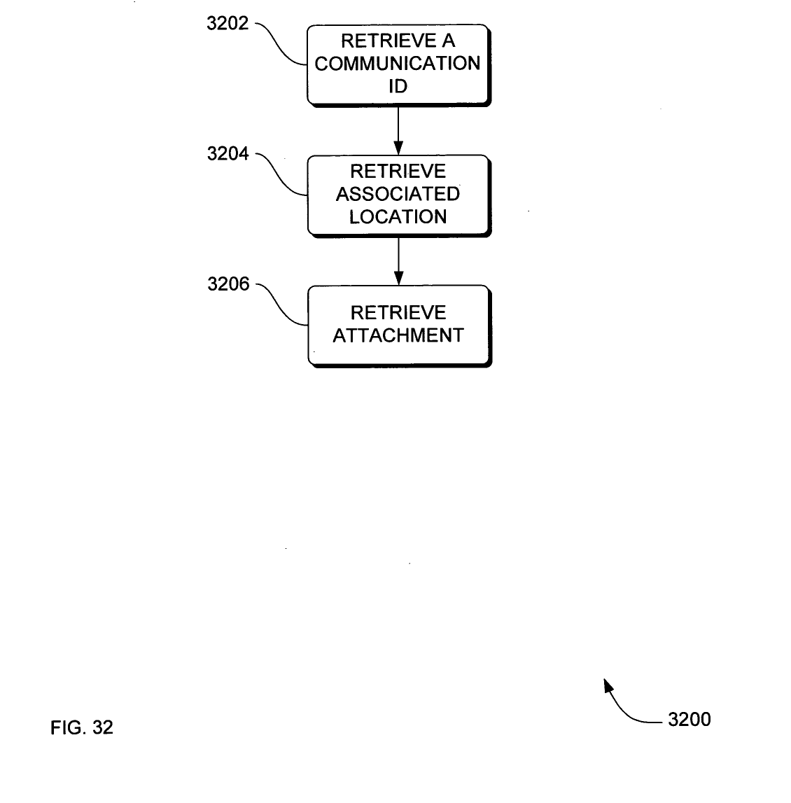

Thereafter, in some embodiments, method 3100 includes retrieving 3116 the email data file from the file structure that is operable to store email data other than the email attachment data and method 3100 includes retrieving 3118 the email attachment data file from the file structure that is operable to store email attachment data. One embodiment of retrieving 3118 is described below in FIG. 32.

In essence, method 3100 provides a manner of the storing an attachment of an email, providing on a disk drive of a computer performing method 3100, creating an association of the attachment to the email and later retrieving the attachment in reference to the association.

In some embodiments of method 3100 in FIG. 31 above and method 3200 in FIG. 32 below, the subject of each method is an embedded graphic file instead of an attachment. An email communication may be associated with an embedded graphic file. In these embodiments, the graphic file is treated substantially similar to the attachment; more specifically, the embedded graphic file is stored on a disk drive of a computer performing method 3100, an association between the embedded graphic file and the email is created and later the embedded graphic file is retrieved from the disk drive in reference to the association.

FIG. 32 is a flowchart of a method 3200 to retrieve an email attachment according to an embodiment. Method 3200 solves the need in the art for more storage of email data including attachments, without having to resort to archival files. Method 3200 is one embodiment of retrieving 3118 an email attachment in FIG. 3100 above.

Method 3200 includes receiving 3202 a communication identification and retrieving 3204 a location associated with the communication identification. In some embodiments, the communication identification is retrieved from a data structure that associates the attachment data with the email data such as an entry in the attachment table 900. Thereafter, method 3200 includes retrieving 3206 the attachment from a file structure that is operable to store email attachment data in reference to the location.

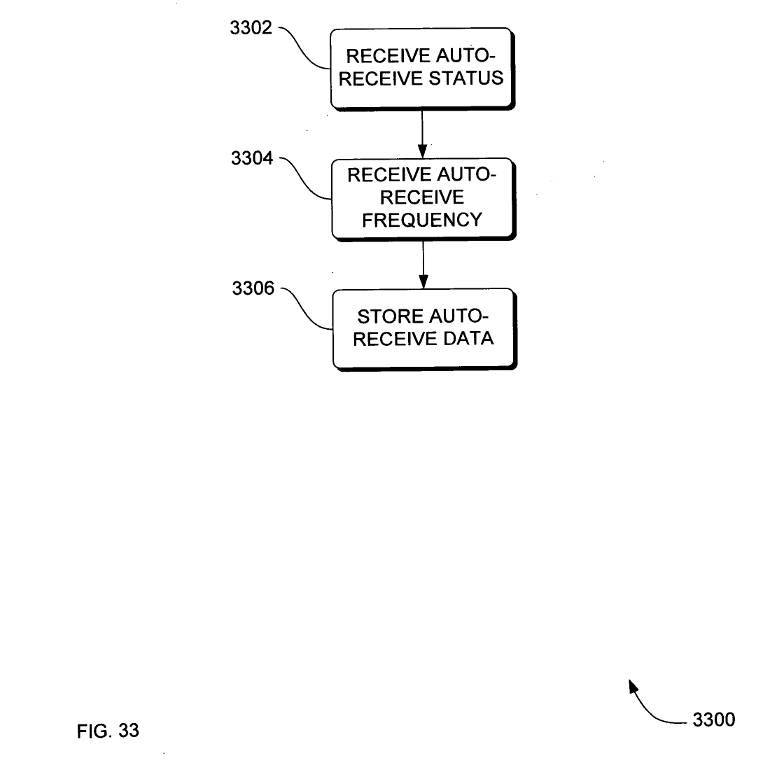

FIG. 33 is a flowchart of a method 3300 to manage auto-receive according to an embodiment. Method 3300 provides a means of determining from a user a number of parameters pertinent to the email client and performing periodic queries for emails that have not yet been downloaded from an email server to a computer executing the email client.

Method 3300 includes receiving 3302 an indication of the status of checkbox that represents a binary condition. Various embodiments of the data of the auto-receive status include ON/OFF, TRUE/FALSE, CHECKED/UNCHECKED and 0/1. The auto-receive status indicates whether or not auto-receiving of emails is enabled. The indication of the status can be solicited from the user via a checkbox via a graphical user interface.

Method 3300 also includes receiving 3304 an integer value representing the frequency of auto-receiving emails. The units of time of the frequency is predetermined and communicated to a user via a graphical user interface.

Method 3300 also includes storing 3306 the auto-receive status and the auto-receive frequency. In some embodiments, the auto-receive parameters are stored in the mdefault table 2402 in FIG. 24. Thereafter, the auto-receive data is available for access and reference by the email client.

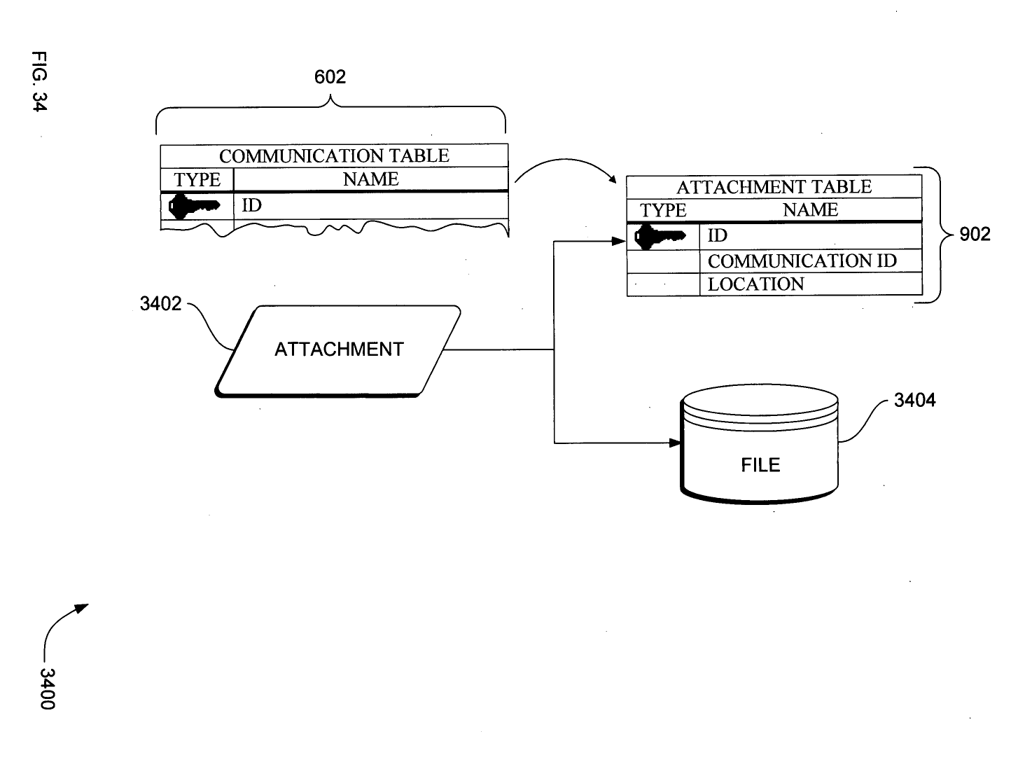

FIG. 34 is a data flow diagram 3400 to manage attachments according to an embodiment. Data flow diagram 3400 solves the need in the art for more storage of email data including attachments, without having to resort to archival files.

Data flow diagram 3400 includes an attachment 3402 of an email that is stored on a mass storage device 3404 in data file structure that is separate from a body of the email. Data describing the attachment 3402 (including the location of the attachment 3402 on the mass storage device 3404) is stored in a record in an attachment table 902 and data describing the email is stored in a record of a communication table 602 (including the location of the record in the attachment table 902. Thus, the attachment 3402 is stored separately from the email on the mass storage device 3402 and the attachment 3402 is associated with the email through the communication table 602. In some embodiments, the location of the attachment 3402 is stored in the communication table 602.

Thus the data flow diagram 3400 supports storage of attachments outside of the email database, which allows the only the emails to be stored in the email database, which in turn reduces, if not eliminates, the amount of storage in the email database required to store attachments. This allows many more emails to be stored in the email database and the attachments to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the attachments in the unused hard disk space separately from the email database not only provides a means to make the much larger amount of unused disk space available to store attachments, but also provides a means to use the email database only for emails, which allows more emails to be stored in the email database. Thus data flow diagram 3400 solves the need in the art for more storage for email data including attachments, without having to resort to archival files.

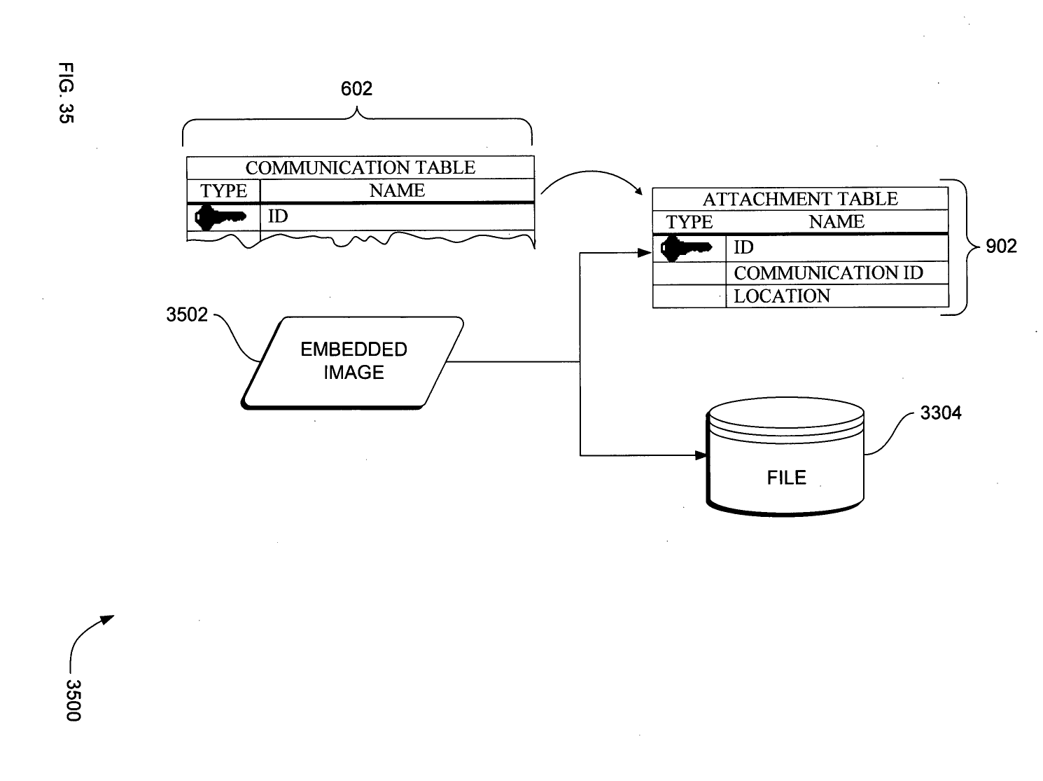

FIG. 35 is a data flow diagram 3500 to manage embedded graphics according to an embodiment. Data flow diagram 3500 solves the need in the art for more storage of email data including embedded images, without having to resort to archival files.

Data flow diagram 3500 includes an embedded image 3502 of an email that is stored on a mass storage device 3404 in data file structure that is separate from the email. Data describing the embedded image 3502 (including the location of the embedded image 3502 on the mass storage device 3404) is stored in a record in an attachment table 902 and data describing the email is stored in a record of a communication table 602 (including the location of the record in the attachment table 902. Thus, the embedded image 3502 is stored separately from the email on the mass storage device 3502, the embedded image 3502 is associated with the email through the communication table 602. In some embodiments, the location of the embedded image 3502 is stored in the communication table 602.

Thus the data flow diagram 3500 supports storage of embedded images outside of the email database, which allows the only the emails to be stored in the email database, which in turn reduces, if not eliminates, the amount of storage in the email database required to store embedded images. This allows many more emails to be stored in the email database and the embedded images to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the embedded images in the unused hard disk space separately from the email database not only provides a means to make the much larger amount of unused disk space available to store embedded images, but also provides a means to use the email database only for emails, which allows more emails to be stored in the email database. Thus data flow diagram 3500 solves the need in the art for more storage for email data including embedded images, without having to resort to archival files.

FIG. 34 and FIG. 35 show that embedded images and attachments can be managed identically, using the same data structures. In some embodiments, an embedded image 3502 from an email is stored in a same subdirectory as an attachment 3402 from the same email.

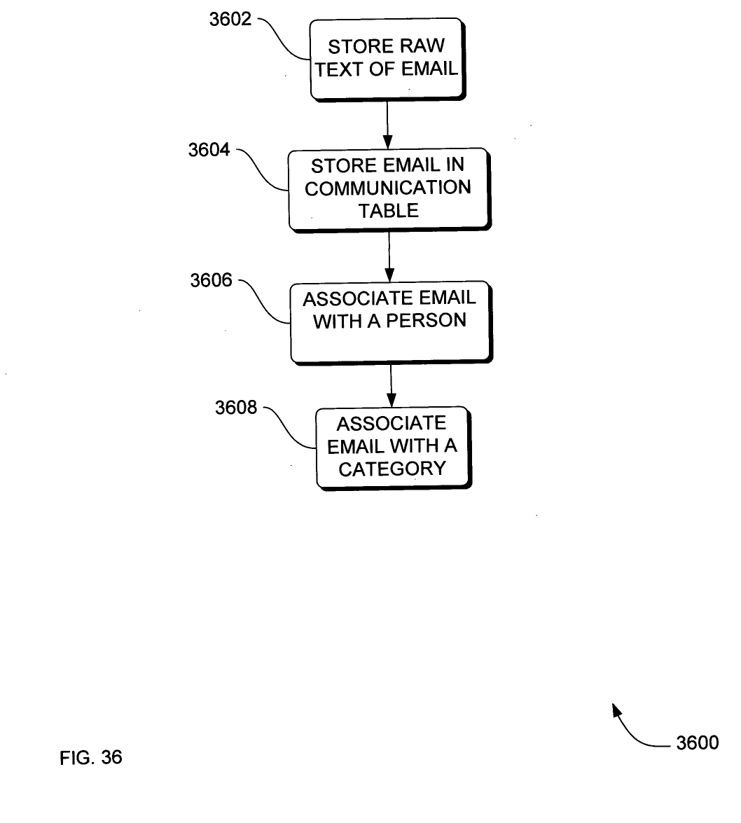

FIG. 36 is a flowchart of a method 3600 to import an email communication according to an embodiment.

Method 3600 includes receiving and storing 3602 raw text of an email and creating a record in a communication table, such as communication table 602. In some embodiments, the received email in one of a plurality of emails in a .mbx file, a .csv file or an .eml file.

Method 3600 also includes storing 3604 the email data in a communication table, such as communication table 6.02 that is described above. In some embodiments, the storing 3604 includes creating an entry in the communication table and copying the email data to the entry.

Method 3600 also includes associating 3606 the stored email data with a person. One example of associating 3606 includes updating a field in the stored communication entry indicating a person indicated by a “emailfromaddress” who is represented in a entry in a person table 302.

Method 3600 also includes associating 3608 the stored email data with a category. One example of associating 3608 includes updating a field in the stored communication entry indicating a category that is described in an entry in a category table 202.

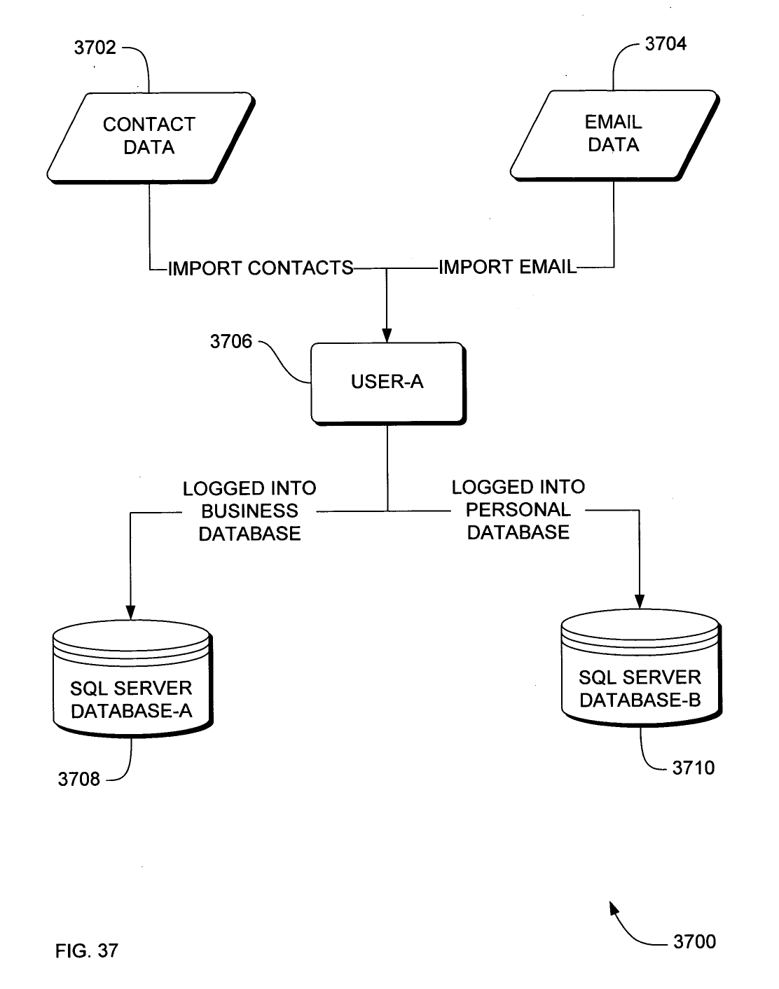

FIG. 37 is a data flow diagram 3700 to import data into an email client according to an embodiment.

Data flow diagram 3700 includes contact data 3702 and email data 3704 that is received by the email client (not shown) in association with a particular user of the email client, such as User-A 3706. In some embodiments, the contact data 3702 and the email data 3704 is in the same file format as the received email in FIG. 36, such as in one of a plurality of emails in a .mbx file, a .csv file or an .eml file.

Depending upon which of a number of databases User-A 3706 is logged into, such as SQL Server Database-A 3708 or SQL Server Database-B 3710, the contact data 3702 and email data 3704 will be stored into the database that the user is logged into. Any number of users, such as User-B, User-C or User-D can be associated with any number of databases, such as Database-C, Database-D or Database-E. In some embodiments, the method of FIG. 36 is performed during the storing in FIG. 37.

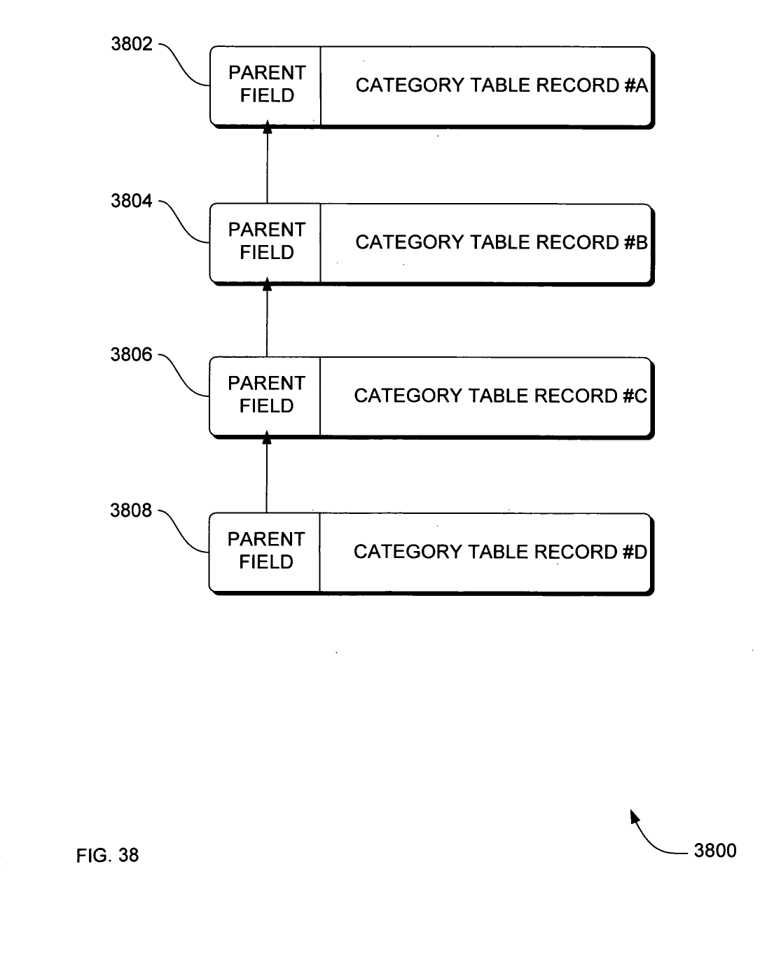

FIG. 38 is a dataflow diagram 3800 to manage email communications according to an embodiment.

Dataflow diagram 3800 provides a flexible hierarchy of categories, the hierarchy providing an unlimited number of levels within the hierarchy of categories. The hierarchy is accomplished by providing a linked list of records in a category table.

In the embodiment of linked category records shown in FIG. 38, all but a final parent record links to the immediate parent record of each category record. In the example shown in FIG. 38, final parent record for category table record #A 3802 is linked by a child category table record #B 3804. This pattern repeats for as many successive child category table records as necessary. More specifically, parent record for category table record #B 3804 is linked by a child category table record #C 3806, parent record for category table record #C 3806 is linked by a child category table record #D 3808.

In some embodiments, dataflow diagram 3800 includes a treeview control (not shown) to manage the hierarchy of category records. The treeview control recursively traverses the hierarchy. In a communication table, records are linked to category records, that are in turn linked to other category records through a parent filed that contains the Id number of the patent category. In a person table, records are linked to categories, but the categories are linked to parent categories through the parent field of the category record.

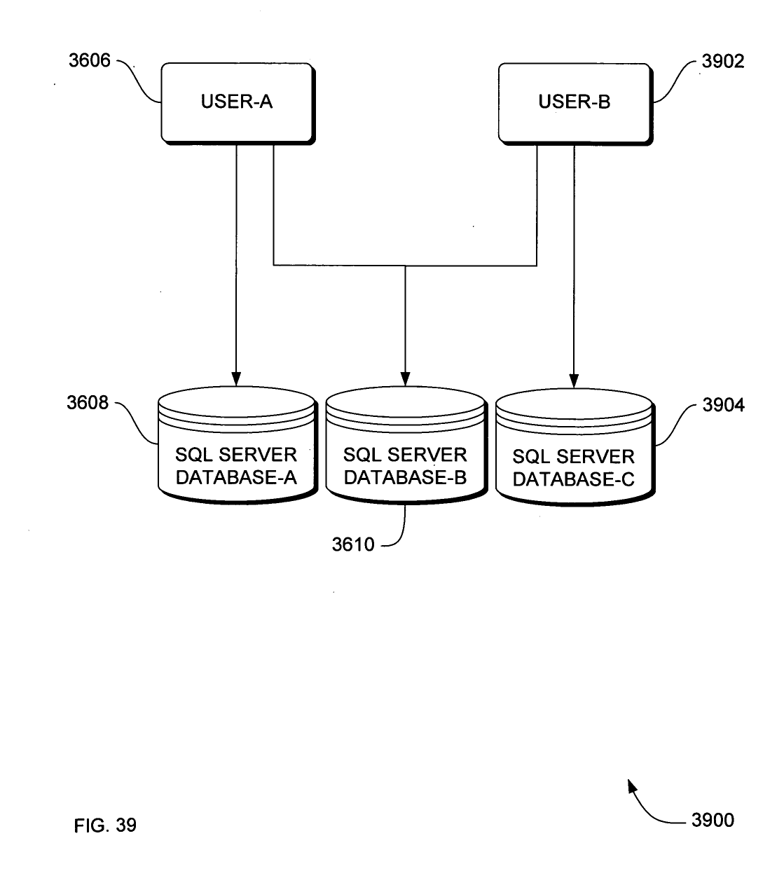

FIG. 39 is a dataflow diagram 3900 to manage multiple users according to an embodiment.

Dataflow diagram 3900 includes a User-A 3706 who accesses a Server Database-A 3708 and/or SQL Server Database-B 3710. Dataflow diagram also includes User-B 3902 who accesses the Server Database-B 3710 and/or SQL Server Database-C 3904.

In some embodiments, the User-A 3706 is named “admin” and the User-B 3902 is named “user.”

Dataflow diagram 3900 shows two different embodiments of database access. In the first embodiment, User-A 3706 has exclusive access to Server Database-A 3708 and User-B 3902 has exclusive access to SQL Server Database-C 3904. In the second embodiment, User-A 3706 and User-B 3902 share access to SQL Server Database-B 3710.

When a user is added to a setup table, such as setup table 1902, a database name, servername and password are added to that user for a new database or one that already exists. If a non-existent database is specified, that database is created, and then the database is connected to servername and password.

In some embodiments, any person can have multi-databases: personal, business, etc. For example, one user can have and access a personal database of emails and people, and then at some point, leave the program, and log into another business database that is there database also, (separate from the personal database), so no mixing of emails. Access to each database is through the login that allows entry. In another example, any set of users can share one database in which different users can use the same database by just both submitting the login credentials to the email client. In another example, all users can have separate databases, in which each user has their own database so that no other user could delete their emails. In another example, each user can import to their database connecting emails to any topic, in which a user logs into any database, that user will have the authorization to import into that database. In another example, when a user logs in as a user with access to a database, all importing by the email client directed by the user do applies to the database the user has the ability to which to connect.

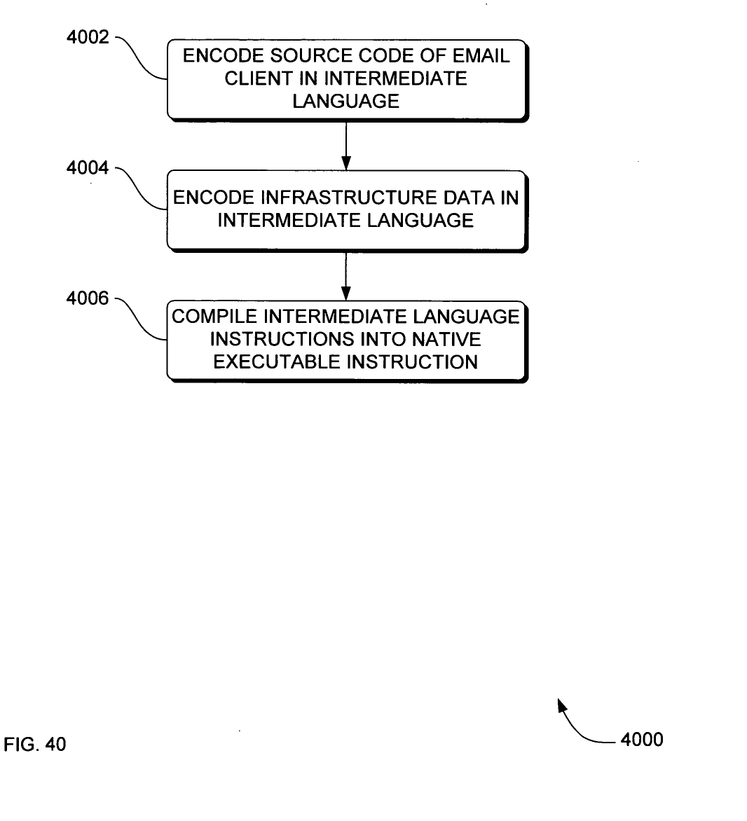

FIG. 40 is a flowchart of a method 4000 to create an executable managed code email client according to an embodiment. Method 4000 solves the need in the art for an operationally stable email client.

Managed code is executable computer instructions whose execution is managed by a runtime module, such as the Microsoft .NET Framework Common Language Runtime (CLR). The runtime module refers to an architecture of cooperation between natively executing instructions and the runtime module. This architecture specifies that at any point of execution, the runtime module may stop an executing processor (CPU) and retrieve information specific to the current CPU instruction address. Information that must be query-able generally pertains to runtime state, such as register or stack memory contents.

Method 4000 includes encoding 4002 source code of an email client in an intermediate language (IL). An IL describes how the information is to be encoded, and programming languages that target the runtime module emit the correct encoding. One embodiment of an IL is the Common Language Infrastructure (CLI) Standard published by the International Organization for Standardization (ISO) in Geneva Switzerland, of which the CLR is the primary commercial implementation.

In addition, infrastructure data such as associated metadata, or symbolic information that describes all of the entry points and the constructs exposed in the IL (e.g., methods, properties) and their characteristics, are encoded 4004 in the IL.

The IL instructions are compiled 4006 into native executable instructions. Because the compiling 4006 is performed by the managed execution environment (or, in some embodiment, by a runtime-aware compiler that accesses information on how to target the managed execution environment), the managed execution environment can provide information about what function the instructions will perform. The managed execution environment can insert traps and appropriate garbage collection hooks, exception handling, type safety, array bounds and index checking. For example, such a compiler creates stack frames so that a garbage collector can run in the background on a separate thread, constantly traversing the active call stack, finding all the roots, identifying all of the live objects. In addition because the IL instructions have information describing type safety, an execution engine will maintain type safety eliminating some programming mistakes that often lead to security holes. The managed execution provides an operationally stable email client.

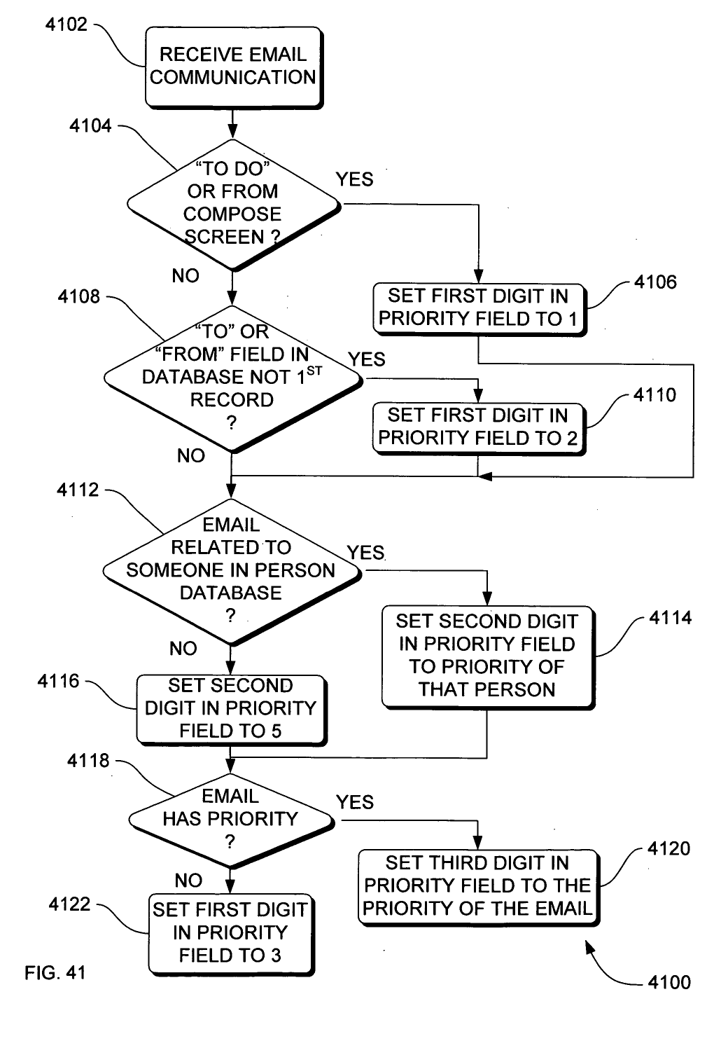

FIG. 41 is a flowchart of a method 4100 to prioritize email communications according to an embodiment. Method 4100 solves the need in the art for improved sorting/prioritization of emails.

Method 4100 includes receiving 4102 an email communication. A numeric priority field is set to numeric “0” in all digits of the priority field. The leading digit (the first digit) represents the overall importance of the email communication. A second digit represents the person importance of the email communication, and a third digit represents the email priority of the email communication. Some embodiments of the priority field comprise 3 digits, as the digits described above, other embodiments include a subset of the above described digits, other embodiments includes the above three digits and other digits, and other embodiments include a subset of the above three digits and other digits.

A determination 4104 as to whether or not the email communication is a “To Do” communication or whether or not the email communication was created from a compose screen of the email client. If either determination is true, the first digit in a numeric priority field is set 4106 to numeric 1. If both determinations 4104 are false, then a determination 4108 is performed as to whether or not the value in the “to” or the “from of the email communication is found in a database of email addresses other than the owner of the email client, the owner of the email client being indicated in the 1^{st} entry in the database in some embodiments. If determination 4108 is true, then the first digit in the numeric priority field is set 4110 to numeric 2.

Thereafter a determination 4112 as to whether or not the email communication is related to a person in the database. If the determination 4112 is true, then the second digit in the priority field is set 4114 to the priority of that person, otherwise the second digit in the priority field is set 4116 to 5.

Thereafter, a determination 4118 as to whether or not the email communication has a priority is made. If the determination 4118 is true, then the third digit in the priority field is set 4120 to the priority of the email communication. If the determination 4118 is false, then the third digit in the priority field is set 4122 to an average, middle, representation, such as numeric 3.

Thus, a priority of each email communication is set or determined. The emails can be displayed by the email client in descending numeric order indicated by the priority field.

In some embodiments, methods 3000-4100 are implemented as a computer data signal embodied in a carrier wave that represents a sequence of instructions which, when executed by a processor, such as processor 2904 in FIG. 29, cause the processor to perform the respective method. In other embodiments, methods 3000-4100 are implemented as a computer-accessible medium having executable instructions capable of directing a processor, such as processor 2904 in FIG. 29, to perform the respective method. In varying embodiments, the medium is a magnetic medium, an electronic medium, or an optical medium.

### Conclusion

An email client is described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

We claim:

1. A computer-accessible medium to provide a reliable apparatus for managing email data, the medium comprising:
an apparatus operable to store at least a portion of the email data through an interface to a database manager; the database manager having a high level security manager; and
an apparatus operable to retrieve email data through the interface to the database manager.

2. The computer-accessible medium of claim 1, wherein the medium further comprises:
an apparatus operable to receive the at least a portion of the email data from a network.

3. A computer-accessible medium to provide a stable email client program, the medium comprising:
an interface to a database manager, the database manager having a high level security manager; and
a second program operably coupled to the database manager, the second program operable to receive the at least a portion of the email data from a network, store the at least a portion of the email data through the interface to a database manager and retrieve the at least a portion of the email data through the interface to a database manager.

4. A computer-accessible medium to provide a reliable apparatus of managing email data, the medium comprising:
an apparatus operable to store at least a portion of the email data through an interface to a relational database manager; and
an apparatus operable to retrieve the at least a portion of the email data through the interface to the relational database manager.

5. A computer-accessible medium to provide a reliable apparatus of managing email data, the medium comprising:
an apparatus operable to store at least a portion of the email data through an interface to a structured-query-language database manager; and
an apparatus operable to retrieve at least a portion of the email data through the interface to the structured-query-language database manager.

6. A computer-accessible medium having executable instructions to manage email associations, the executable instructions capable of directing a processor to perform:
receiving an email;
determining that a sender of the email is stored in a database; and
creating an association in the database between the email and the sender.

7. The computer-accessible medium of claim 7, wherein the executable instructions capable of directing the processor to perform the determining further comprise executable instructions capable of directing the processor to perform:
comparing a sender email address contained in the email to a table in a database.

8. A computer-accessible medium having executable instructions to provide storage for email data including attachments, the executable instructions capable of directing a processor to perform:
creating a file structure that is operable to store email attachment data; and
creating a file structure that is operable to store email data other than the email attachment data.

9. The computer-accessible medium of claim 8, the medium further comprising executable instructions capable of directing a processor to perform:
populating the file structure that is operable to store the email data other than the email attachment data with an email data file other than email attachment data.

10. The computer-accessible medium of claim 9, the medium further comprising executable instructions capable of directing a processor to perform:
retrieving the email data file from the file structure that is operable to store email data other than the email attachment data.

11. The computer-accessible medium of claim 9, the medium further comprising executable instructions capable of directing a processor to perform:
creating a data structure that is operable to associate each attachment data with an email data.

12. The computer-accessible medium of claim 9, the medium further comprising executable instructions capable of directing a processor to perform:
populating the file structure that is operable to store email attachment data with an email attachment file.

13. The computer-accessible medium of claim 12, the medium further comprising executable instructions capable of directing a processor to perform:
retrieving the email attachment data file from the file structure that is operable to store email attachment data.

14. The computer-accessible medium of claim 13, wherein the executable instructions capable of directing the processor to perform the retrieving further comprise executable instructions capable of directing the processor to perform:
receiving a communication identification;
retrieving the location associated with the communication identification from a data structure that associates the attachment data with the email data; and
retrieving the attachment from a file structure that is operable to store email attachment data in reference to the location.

15. A computer-accessible medium having executable instructions to manage receipt of email communication, the executable instructions capable of directing a processor to perform:
receiving an indication of a status of checkbox that represents a binary condition; and
receiving an integer value representing the frequency of auto-receiving emails

16. The computer-accessible medium of claim 15, wherein the executable instructions capable of directing the processor to perform receiving an indication of a status of checkbox are performed before the executable instructions capable of directing the processor to perform receiving an integer value.

17. The computer-accessible medium of claim 15, the medium further comprising executable instructions capable of directing a processor to perform:
storing the auto-receive status and the auto-receive frequency

18. The computer-accessible medium of claim 15, wherein the binary condition further comprises:
ON/OFF, TRUE/FALSE, CHECKED/UNCHECKED and 0/1.

19. The computer-accessible medium of claim 15, wherein the binary condition further comprises:
an indication of whether or not auto-receiving of emails is enabled.

20. The computer-accessible medium of claim 15, wherein the binary condition further comprises:
being solicited from a user via a checkbox via a graphical user interface.

21. A computer-accessible medium having executable instructions to manage at least one attachment of an email communication, the executable instructions capable of directing a processor to perform:
storing a body of the email communication in a first data file structure; and
storing the at least one attachment in a second data file structure.

22. The computer-accessible medium of claim 21, the medium further comprising executable instructions capable of directing a processor to perform:
storing data describing the location of the body of the email communication; and
storing data describing the location of the least one attachment.

23. The computer-accessible medium of claim 22, wherein the executable instructions capable of directing the processor to perform the storing data describing the location of the body of the email communication further comprise executable instructions capable of directing the processor to perform:
storing data describing the location of the body of the email communication in a record of a communication table, and
wherein the executable instructions capable of directing the processor to perform the storing data describing the location of the least one attachment further comprise executable instructions capable of directing the processor to perform:
storing data describing the location of the least one attachment in a record in an attachment table.

24. The computer-accessible medium of claim 21, the medium further comprising executable instructions capable of directing a processor to perform:
storing data describing the location of the first data file structure; and
storing data describing the location of the second data file structure.

25. A computer-accessible medium having executable instructions to manage at least one embedded image of an email communication, the executable instructions capable of directing a processor to perform:
storing a body of the email communication in a first data file structure; and
storing the at least one embedded image in a second data file structure.

26. The computer-accessible medium of claim 25, the medium further comprising executable instructions capable of directing a processor to perform:
storing data describing the location of the body of the email communication; and
storing data describing the location of the least one embedded image.

27. The computer-accessible medium of claim 26, wherein the executable instructions capable of directing the processor to perform the storing data describing the location of the body of the email communication further comprise executable instructions capable of directing the processor to perform:
storing data describing the location of the body of the email communication in a record of a communication table, and
wherein the executable instructions capable of directing the processor to perform the storing data describing the location of the least one embedded image further comprise executable instructions capable of directing the processor to perform:
storing data describing the location of the least one embedded image in a record in an embedded image table.

28. The computer-accessible medium of claim 25, the medium further comprising executable instructions capable of directing a processor to perform:
storing data describing the location of the first data file structure; and
storing data describing the location of the second data file structure.

29. A computer-accessible medium having executable instructions to import an email communication, the executable instructions capable of directing a processor to perform:
receiving raw text of an email communication;
storing the raw text of an email communication; and
storing the raw text of the email communication in a record of a communication table; wherein the record of the communication table further comprises:
a field storing data representing an indexed key field representing an identification of a communication; and
a field storing data representing identification of a person to whom the communication was sent.

30. The computer-accessible medium of claim 29, the medium further comprising executable instructions capable of directing a processor to perform:
associating the stored raw text of the email communication with a person.

31. The computer-accessible medium of claim 30, wherein the executable instructions capable of directing the processor to perform the associating the stored raw text of the email communication with the person further comprise executable instructions capable of directing the processor to perform:
updating a field in the stored communication entry indicating a person indicated by a “emailfromaddress” who is represented in a entry in a person table.

32. The computer-accessible medium of claim 29, the medium further comprising executable instructions capable of directing a processor to perform:
associating the stored raw text of the email communication with a category.

33. The computer-accessible medium of claim 32, wherein the executable instructions capable of directing the processor to perform the associating the stored raw text of the email communication with the category further comprise executable instructions capable of directing the processor to perform:
updating a field in the stored communication entry indicating a category that is described in an entry in a category table.

34. The computer-accessible medium of claim 29, wherein the executable instructions capable of directing the processor to perform the storing the raw text of the email communication in a record of a communication table further comprise executable instructions capable of directing the processor to perform:
creating an entry in the communication table; and
copying the raw text email data to the entry;

35. A computer-accessible medium having executable instructions to create an executable managed code email client, the executable instructions capable of directing a processor to perform:
encoding source code of an email client into intermediate language instructions;
encoding infrastructure data into intermediate language instructions, the infrastructure data further comprising associated metadata, and symbolic information that describes all of the entry points and the constructs exposed in the intermediate language; and
compiling the intermediate language instructions into native executable instructions.

36. The computer-accessible medium of claim 35, wherein the executable instructions capable of directing the processor to perform the compiling further comprise executable instructions capable of directing the processor to perform:
creating stack frames so that a garbage collector can run in the background on a separate thread, constantly traversing the active call stack, finding all the roots, identifying all of the live objects

37. The computer-accessible medium of claim 35, wherein the intermediate language instructions further comprises apparatus:
information describing type safety.

38. The computer-accessible medium of claim 35, wherein the intermediate language further comprises:
an intermediate language that conforms to the Common Language Infrastructure (CLI) Standard.

39. A computer-accessible medium having executable instructions to prioritize an email communication, the executable instructions capable of directing a processor to perform:
setting a leading digit in a numeric priority field to numeric 1, if the email communication is a “To Do” communication or if the email communication was created from a compose screen of an email client;
setting the leading digit in the numeric priority field to numeric 2, if a “to” or a “from” field of the email communication is found in a database of email addresses other than the owner of the email client;
setting a second digit in the numeric priority field to a priority of a person, if the email communication is related to a person in the database;
setting the second digit in the numeric priority field to a numeric 5, if the email communication is not related to a person in the database;
setting a third digit in the numeric priority field to a priority of the email communication, if the email communication includes a priority; and
setting the third digit in the numeric priority field to an average value, if the email communication includes no priority.

40. The computer-accessible medium of claim 39, wherein the executable instructions capable of directing the processor to perform the setting the third digit in the numeric priority field to an average value further comprise executable instructions capable of directing the processor to perform:
setting the third digit in the numeric priority field to a numeric 3.

41. A computer-accessible medium having executable instructions to prioritize an email communication, the executable instructions capable of directing a processor to perform:
setting a digit in a numeric priority field to an overall importance of the email communication;
setting a digit in a numeric priority field to a person importance of the email communication; and
setting a digit in a numeric priority field to an email importance of the email communication.

42. A computer-accessible medium to provide more storage for email data including attachments, the medium comprising:
a file structure that is operable to store email attachment data; and
a file structure that is operable to store email data other than email attachment data.

43. The computer-accessible medium of claim 42, wherein the medium further comprises:
a data structure that associates each attachment data with an email data.

44. A computer-readable medium having stored thereon a category data structure comprising:
a field storing data representing an indexed key field representing an identification of a category; and
a field storing data representing a description of the category.

45. The computer-readable medium of claim 44, wherein the category data structure further comprises:
a field storing data representing a note on the category.

46. The computer-readable medium of claim 44, wherein the data structure further comprises:
a table data structure.

47. A computer-readable medium having stored thereon a persons data structure comprising:
a field storing data representing an indexed key field representing an identification of a person; and
a field storing data representing a priority of the person.

48. The computer-readable medium of claim 47, wherein the persons data structure further comprises:
a field storing data representing a first name of the person;
a field storing data representing a middle name of the person;
a field storing data representing a last name of the person;
a field storing data representing an address of the person;
a field storing data representing a city of the person;
a field storing data representing a state of the person;
a field storing data representing a country of the person;
a field storing data representing a country other of the person;
a field storing data representing a zip code identification of the person;
a field storing data representing a zip code of the person;
a field storing data representing a title of the person;
a field storing data representing a company name of the person;
a field storing data representing a business address of the person;
a field storing data representing a business city of the person;
a field storing data representing a business state identification of the person;
a field storing data representing a business state of the person;
a field storing data representing a business country of the person;
a field storing data representing a business country other of the person;
a field storing data representing a business zip code identification of the person;
a field storing data representing a business zip code of the person;
a field storing data representing a home phone of the person;
a field storing data representing a work phone of the person;
a field storing data representing a fax number of the person;
a field storing data representing a cell phone number of the person;
a field storing data representing an other phone of the person;
a field storing data representing a first email address of the person;
a field storing data representing a second email address of the person;
a field storing data representing a third email address of the person;
a field storing data representing a contact of the person;
a field storing data representing a Internet URL of the person;
a field storing data representing notes of the person;
a field storing data representing an anniversary date of the person; and
a field storing data representing a birthday date of the person.

49. The computer-readable medium of claim 47, wherein the data structure further comprises:
a table data structure.

50. A computer-readable medium having stored thereon a category/person relationships data structure comprising:
a field storing data representing an indexed key field representing an identification of a category/person; and
a field storing data representing a category.

51. The computer-readable medium of claim 50, wherein the category/person relationships data structure further comprises:
a field storing data representing a person.

52. The computer-readable medium of claim 50, wherein the data structure further comprises:
a table data structure.

53. A computer-readable medium having stored thereon a category data structure comprising:
a field storing data representing an indexed key field representing an identification of a category; and
a field storing data representing a description of the category, and having stored thereon a persons data structure comprising:
a field storing data representing an indexed key field representing an identification of a person; and
a field storing data representing a priority of the person, and having stored thereon a category/person relationships data structure comprising:
a field storing data representing an indexed key field representing an identification of a category/person; and
a field storing data representing a category, and having stored thereon:
a connection providing a one-to-many relationship from the persons data structure to the category/person relationships data structure; and
a connection providing a one-to-many relationship from the category data structure to the category/person relationships data structure.

54. The computer-readable medium of claim 53, wherein the category data structure further comprises:
a field storing data representing a note on the category.

55. The computer-readable medium of claim 53, wherein the data structure further comprises:
a table data structure.

56. A computer-readable medium having stored thereon a communication data structure comprising:
a field storing data representing an indexed key field representing an identification of a communication; and
a field storing data representing identification of a person to whom the communication was sent.

57. The computer-readable medium of claim 56, wherein the communication data structure further comprises:
a field storing data representing identification of a person from whom the communication was sent;
a field storing data representing a topic of the communication;
a field storing data representing a read/unread status of the communication;
a field storing data representing an over importance of the communication;
a field storing data representing an importance of the person of the communication;
a field storing data representing an importance of the communication;
a field storing data representing a subject of the communication;
a field storing data representing a creation date the communication;
a field storing data representing a “to” email address of the communication;
a field storing data representing a “from” email address of the communication;
a field storing data representing a name of the communication;
a field storing data representing a reply address of the communication;
a field storing data representing a contents of the communication;
a field storing data representing a HTML status of the communication;
a field storing data representing a HTML contents status of the communication;
a field storing data representing a incoming status of the communication; and
a field storing data representing a “to do” status of the communication.

58. The computer-readable medium of claim 56, wherein the data structure further comprises:
a table data structure.

59. A computer-readable medium having stored thereon a persons and communications relationships data structure comprising:
a persons data structure comprising:
a field storing data representing an indexed key field representing an identification of a person; and
a field storing data representing a priority of the person,
a communication data structure comprising:
a field storing data representing an indexed key field representing an identification of a communication; and
a field storing data representing identification of a person to whom the communication was sent,
having stored thereon:
a connection providing a one-to-many relationship from the persons data structure to the communication data structure.

60. The computer-readable medium of claim 59, wherein the communication data structure further comprises:
a field storing data representing identification of a person from whom the communication was sent.

61. The computer-readable medium of claim 59, wherein each of the data structures further comprises:
a table data structure.

62. A computer-readable medium having stored thereon an attachment data structure comprising:
a field storing data representing an indexed key field representing an identification of an attachment; and
a field storing data representing a communication identification.

63. The computer-readable medium of claim 62, wherein the attachment data structure further comprises:
a field storing data representing a location of an attachment file.

64. The computer-readable medium of claim 62, wherein the data structure further comprises:
a table data structure.

65. A computer-readable medium having stored thereon an attachment and communications relationships data structure comprising:
an attachment data structure comprising:
a field storing data representing an indexed key field representing an identification of an attachment; and
a field storing data representing a priority of the person,
a communication data structure comprising:
a field storing data representing an indexed key field representing an identification of a communication; and
a field storing data representing identification of a person to whom the communication was sent,
having stored thereon:
a connection providing a one-to-many relationship from the communication data structure to the attachment data structure.

66. The computer-readable medium of claim 65, wherein the communication data structure further comprises:
a field storing data representing identification of a person from whom the communication was sent.

67. The computer-readable medium of claim 65, wherein each of the data structures further comprises:
a table data structure.

68. A computer-readable medium having stored thereon a zip code data structure comprising:
a field storing data representing an indexed key field representing an identification of a zip code; and
a field storing data representing a zip code.

69. The computer-readable medium of claim 68, wherein the zip code data structure further comprises:
a field storing data representing a city; and
a field storing data representing a state code.

70. The computer-readable medium of claim 68, wherein the data structure further comprises:
a table data structure.

71. A computer-readable medium having stored thereon a persons and zip code relationships data structure comprising:
a persons data structure comprising:
a field storing data representing an indexed key field representing an identification of a person; and
a field storing data representing a priority of the person,
a zip code data structure comprising:
a field storing data representing an indexed key field representing an identification of a zip code; and
a field storing data representing a zip code, having stored thereon:
a connection providing a one-to-many relationship from the zip code data structure to the persons data structure.

72. The computer-readable medium of claim 71, wherein the communication data structure further comprises:
a field storing data representing identification of a person from whom the communication was sent.

73. The computer-readable medium of claim 71, wherein the data structure further comprises:
a table data structure.

74. A computer-readable medium having stored thereon a recurring data structure comprising:
a field storing data representing an indexed key field representing an identification of recurrence; and
a field storing data representing an identification of a person.

75. The computer-readable medium of claim 74, wherein the recurring data structure further comprises:
a field storing data representing a period of recurrence;
a field storing data representing a type of recurrence;
a field storing data representing a day of the week of the recurrence;
a field storing data representing a which of the recurrence;
a field storing data representing a which first of the recurrence;
a field storing data representing a month of the recurrence;
a field storing data representing a lead time of recurrence;
a field storing data representing a short description of the recurrence;
a field storing data representing a long description of the recurrence;
a field storing data representing a from email address of the recurrence;
a field storing data representing a first date of the recurrence;
a field storing data representing a second date of the recurrence;
a field storing data representing a start time of the recurrence;
a field storing data representing an end time of the recurrence;
a field storing data representing a maximum status of the recurrence;
a field storing data representing a maximum occurrences of the recurrence;
a field storing data representing a last date that the occurrence was generated; and
a field storing data representing number of remaining occurrences.

76. The computer-readable medium of claim 74, wherein the data structure further comprises:
a table data structure.

77. A computer-readable medium having stored thereon a persons and recurrences relationships data structure comprising:
a persons data structure comprising:
a field storing data representing an indexed key field representing an identification of a person; and
a field storing data representing a priority of the person,
a recurrences data structure comprising:
a field storing data representing an indexed key field representing an identification of a recurrences; and
a field storing data representing identification of a person,
having stored thereon:
a connection providing a one-to-many relationship from the persons data structure to the recurrences data structure.

78. The computer-readable medium of claim 77, wherein the communication data structure further comprises:
a field storing data representing identification of a person from whom the communication was sent.

79. The computer-readable medium of claim 78, wherein the data structure further comprises:
a table data structure.

80. A computer-readable medium having stored thereon a state data structure comprising:
a field storing data representing an indexed key field representing an identification of a state; and
a field storing data representing an abbreviation of the state.

81. The computer-readable medium of claim 80, wherein the state data structure further comprises:
a field storing data representing a name of the state.

82. The computer-readable medium of claim 80, wherein the data structure further comprises:
a table data structure.

83. A computer-readable medium having stored thereon a persons and state relationships data structure comprising:
a persons data structure comprising:
a field storing data representing an indexed key field representing an identification of a person; and
a field storing data representing a priority of the person,
a state data structure comprising:
a field storing data representing an indexed key field representing an identification of a state; and
a field storing data representing an abbreviation of the state,
having stored thereon:
a connection providing a one-to-many relationship from the state data structure to the persons data structure.

84. The computer-readable medium of claim 57, wherein the persons data structure further comprises:
a field storing data representing an identification of a person.

85. The computer-readable medium of claim 83, wherein each of the data structures further comprises:
a table data structure.

86. A computer-readable medium having stored thereon a country data structure comprising:
a field storing data representing an indexed key field representing an identification of a country; and
a field storing data representing a name of the country.

87. The computer-readable medium of claim 86, wherein the data structure further comprises:
a table data structure.

88. A computer-readable medium having stored thereon a persons and country relationships data structure comprising:
a persons data structure comprising:
a field storing data representing an indexed key field representing an identification of a person; and
a field storing data representing a priority of the person,
a country data structure comprising:
a field storing data representing an indexed key field representing an identification of a country; and
a field storing data representing a name of the country,
having stored thereon:
a connection providing a one-to-many relationship from the country data structure to the persons data structure.

89. The computer-readable medium of claim 88, wherein the persons data structure further comprises:
a field storing data representing an identification of a person.

90. The computer-readable medium of claim 88, wherein the data structure further comprises:
a table data structure.

91. A computer-readable medium having stored thereon a setup data structure comprising:
a field storing data representing an indexed key field representing an identification of a setup; and
a field storing data representing a log-in of the setup.

92. The computer-readable medium of claim 91, wherein the setup data structure further comprises:
a field storing data representing an email address;
a field storing data representing a mail server;
a field storing data representing a first Microsoft user name;
a field storing data representing a first Microsoft password;
a field storing data representing a second mail server;
a field storing data representing a second Microsoft user name;
a field storing data representing a second Microsoft password;
a field storing data representing a third mail server;
a field storing data representing a third mail server;
a field storing data representing a third Microsoft password;
a field storing data representing a standalone status;
a field storing data representing a password;
a field storing data representing a first name;
a field storing data representing a middle name;
a field storing data representing a last name;
a field storing data representing a local area code;
a field storing data representing a start up date;
a field storing data representing a date path;
a field storing data representing a document path;
a field storing data representing a server name;
a field storing data representing a super administrator password;
a field storing data representing a database name; and
a field storing data representing a user information.

93. The computer-readable medium of claim 91, wherein the data structure further comprises:
a table data structure.
